(19) United States
(12) Patent Application Publication
(10) Pub. No.: US 2013/0301114 A1
(43) Pub. Date: Nov. 14, 2013

(54) ACOUSTO-OPTIC IMAGING DEVICE

(71) Applicant: Panasonic Corporation, Osaka (JP)

(72) Inventors: Ushio SANGAWA, Nara (JP); Takuya IWAMOTO, Osaka (JP); Yuriko KANEKO, Nara (JP); Masahiko HASHIMOTO, Osaka (JP)

(21) Appl. No.: 13/941,913

(22) Filed: Jul. 15, 2013

Related U.S. Application Data
(63) Continuation of application No. PCT/JP2012/006800, filed on Oct. 24, 2012.

(30) Foreign Application Priority Data
Oct. 24, 2011 (JP) 2011-233266

(51) Int. Cl. G02F 1/33

(52) U.S. Cl. CPC G02F 1/33
USPC 359/305

(57) ABSTRACT

An acousto-optic imaging device disclosed in the present application includes: an acoustic wave source; an acoustic lens system for converting a scattered wave produced by irradiation of an object with an acoustic wave emitted from the acoustic wave source into a predetermined converged state; an acousto-optic medium section which is arranged such that a scattered wave transmitted through the acoustic lens system is incident on the acousto-optic medium section; a light source for emitting a light beam which is formed by a plurality of superposed monochromatic light rays traveling in different directions; an image formation lens system for condensing diffracted light of a plurality of the monochromatic plane wave light rays produced at the acousto-optic medium section; and an image receiving section for detecting light condensed by the image formation lens system to output an electric signal.

This is a continuation of International Application No. PCT/JP2012/006800, with an international filing date of Oct. 24, 2012, which claims priority of Japanese Patent Application No. 2011-233266, filed on Oct. 24, 2011, the contents of which are hereby incorporated by reference.

### BACKGROUND

1. Technical Field

The present invention relates to an acousto-optic imaging device for imaging an object by means of light and an acoustic wave.

2. Description of the Related Art

When an object is irradiated with an acoustic wave and a resultant scattered wave is guided to an acousto-optic medium section, a medium in the acousto-optic medium section is caused to have uneven density so as to have a varying refractive index distribution because the acoustic wave is a longitudinal wave. Therefore, when light is transmitted through the acousto-optic medium section, diffracted light which is affected by this refractive index distribution is produced. That is, by observing the produced diffracted light, the object can be detected.

Paper entitled “Visualization of the cross section of a sound beam by Bragg diffraction of light,” Applied Physics Letters, vol. 9, no. 12, pp. 425-427, 15 Dec. 1966 by A. Korpel (hereinafter, referred to as Non-patent Document 1) discloses the technique of imaging an object by irradiating the refractive index distribution caused in the acousto-optic medium section with monochromatic light such that Bragg diffracted light is produced. Specifically, as shown in FIG. 20, Non-patent Document 1 discloses the technique of projecting an image of an object 1109 onto a screen 1105 using a laser 1101 and an ultrasonic transducer 1111. A monochromatic light beam emitted from the laser 1101 is converted by a beam expander 1102 and an aperture 1103 into a monochromatic light beam which has a greater beam diameter. The monochromatic light beam passes through cylindrical lenses 1104(a), 1104(b) elongated along the x-axis and a cylindrical lens 1104(c) elongated along the y-axis, where the x-, y-, and z-axes are defined as shown in FIG. 20, and reaches the screen 1105. This optical system, which is formed by three cylindrical lenses, is not in rotational symmetry about an optical axis 1113.

An acoustic cell 1108 which is filled with water 1107 is provided between the cylindrical lenses 1104(a) and 1104(b). The object 1109 is provided in the water 1107 will be described later, diffracted light is produced when the monochromatic light beam passes through the water 1107.

The produced diffracted light has a strong astigmatism. To correct the astigmatism of the produced diffracted light such that an image is formed on the x-z plane and on the y-z plane at the position of the screen 1105, the cylindrical lenses 1104(a), 1104(b), and 1104(c) have different focal lengths.

The focal length of the cylindrical lens 1104(a) is selected such that the monochromatic light beam is focused at the position of a focal plane 1106 on the x-z plane. Since image formation is realized by the cylindrical lens, the focal point is a line which is parallel to the x-axis. The light beam which has passed through the focal plane 1106 diverges in a region behind the focal plane 1106 on the screen 1105 side, and the diverging light beam is then converged by the cylindrical lens 1104(b) so as to be focused again on the screen 1105. In the y-z plane, the monochromatic light beam which has passed through the beam expander 1102 remains as a collimated light beam when it is incident on the cylindrical lens 1104(c). Due to the light-condensing function of the cylindrical lens 1104(c), the light beam is focused on the screen 1105. The installation positions and focal lengths of the respective cylindrical lens are selected not only such that the light beam is focused on the screen 1105 in both the x-z plane and the y-z plane, but also such that an image which is similar to the object 1109 appears on the screen 1105 as a 1st order diffraction image 1112(a) and −1st order diffracted light 1112(b). Since the optical system is not in rotational symmetry about the optical axis 1113 as described above, the 1st order diffraction image 1112(a) and the −1st order diffracted light 1112(b) have distortions. Thus, an optical system which has a distortion whose characteristics are inverse to those of the distortion of the diffracted light is formed using the cylindrical lenses 1104(b), 1104(c) such that the distortion of the diffracted light is corrected, and an image which is similar to the object 1109 is produced on the screen 1105.

The acoustic cell 1108 is provided with the ultrasonic transducer 1111 which is driven by a signal source 1110. The ultrasonic transducer 1111 emits a monochromatic ultrasonic wave onto the object 1109 via the water 1107. The monochromatic ultrasonic wave means an ultrasonic wave in which the acoustic pressure exhibits a time variation in the shape of a sine wave which has a single frequency.

An ultrasonic scattered wave is produced from the object 1109, and the scattered wave propagates through a region of the water 1107 through which the monochromatic light beam passes. The guided mode of the ultrasonic wave propagating in the water is a compression wave (longitudinal wave), and therefore, a refractive index distribution which is identical with the acoustic pressure distribution in the water 1107, i.e., identical with the ultrasonic scattered wave, is caused in the water 1107. For the sake of simplified discussion, it is assumed in the first place that the ultrasonic scattered wave from the object 1109 is a plane wave traveling in the positive direction of the y-axis. Since the ultrasonic scattered wave is monochromatic, a refractive index distribution caused in the water 1107 at a certain moment is a one-dimensional grating in the shape of a sine wave which is repeated at an ultrasonic wavelength. Thus, due to the one-dimensional grating, Bragg diffracted light is produced (of which the ±1st order diffracted light beams are shown in the drawing). The diffracted light appears as a single light spot on the screen 1105. The luminance of the light spot is proportional to the variation of the refractive index of the one-dimensional grating, i.e., the ultrasonic acoustic pressure.

Next, the assumed condition, “the ultrasonic scattered wave is a plane wave”, is eased, and an ultrasonic scattered wave whose wavefront is not planar is considered. The ultrasonic scattered wave whose wavefront is not planar can be represented as one that is obtained by superposing plane waves coming from various directions (in the example considered herein, all the plane waves have equal frequencies). Therefore, when a monochromatic light beam is transmitted through the water 1107 in which the ultrasonic scattered wave whose wavefront is not planar propagates, the light spot of diffracted light derived from the respective plane waves coming from various directions appears on the screen 1105. The intensity of each light spot is proportional to the largeness of the amplitude of each plane wave, and the appearance position on the screen 1105 of each light spot is determined according to the traveling direction of each plane wave. Therefore, real images of the object 1109 appear on the screen 1105 as the 1st order diffraction image 1112(a) and the −1st order diffraction image 1112(b). The relationship between the object and ±1st order diffraction images is the same as the relationship between an object and a real image in common optical cameras in the respect that the aggregation of light spots on the screen 1105 can be regarded as a real image of the object 1109, except that it is a diffraction phenomenon.

### SUMMARY

However, in the above-described techniques, improvement in the resolution of a formed image has been demanded.

One nonlimiting exemplary embodiment of the present application provides an acousto-optic imaging device which is capable of imaging an object with high resolution.

An acousto-optic imaging device which is an embodiment of the present invention includes: an acoustic wave source; an acoustic lens system for converting a scattered wave produced by irradiation of an object with an acoustic wave emitted from the acoustic wave source into a predetermined converged state; an acousto-optic medium section which is arranged such that a scattered wave transmitted through the acoustic lens system is incident on the acousto-optic medium section; a light source for emitting a light beam which is formed by a plurality of superposed monochromatic light rays traveling in different directions, the light beam being incident on the acousto-optic medium section at an angle which is neither perpendicular nor parallel to an acoustic axis of the acoustic lens system; an image formation lens system for condensing diffracted light of a plurality of the monochromatic plane wave light rays produced at the acousto-optic medium section; and an image receiving section for detecting light condensed by the image formation lens system to output an electric signal.

According to an acousto-optic imaging device of one embodiment of the present invention, an ultrasonic scattered wave produced at an object is converted by an acoustic lens system into a wave formed by superposed plane acoustic waves and guided to an acousto-optic medium section, and a light beam which is formed by a plurality of superposed monochromatic light rays traveling in different directions is transmitted through the acousto-optic medium section, so that diffracted light which is based on the refractive index distribution caused in the acousto-optic medium section is produced. Thus, a high resolution image with small coma aberration can be obtained.

Additional benefits and advantages of the disclosed embodiments will be apparent from the specification and Figures. The benefits and/or advantages may be individually provided by the various embodiments and features of the specification and drawings disclosure, and need not all be provided in order to obtain one or more of the same.

### BRIEF DESCRIPTION OF THE DRAWINGS

FIG. 1 is a general configuration diagram showing the first embodiment of the acousto-optic imaging device of the present invention.

FIG. 2 is a ray tracing diagram illustrating the function of an acoustic lens system 6 in the first embodiment.

FIG. 3A is a diagram showing a configuration of a light source 19 in the first embodiment.

FIG. 3B(a) is a diagram showing a configuration of a uniform illumination optical system 31 in the first embodiment. FIG. 3B(b) is a diagram showing another configuration.

FIG. 4A is a diagram showing another configuration of the uniform illumination optical system 31 in the first embodiment.

FIG. 4B is a diagram showing an arrangement of single mode optical fibers.

FIG. 4C is a diagram showing still another configuration of the uniform illumination optical system 31 in the first embodiment.

FIG. 4D is a diagram showing still another configuration of the uniform illumination optical system 31 in the first embodiment.

FIG. 5 is a diagram showing the set position of a uniform illumination plane 43 in the first embodiment.

FIG. 6(a) is a schematic diagram illustrating Bragg diffraction of a plane wave light beam which is caused by a plane acoustic wave in the first embodiment. FIG. 6(b) is a schematic diagram for illustrating the condition for Bragg diffraction caused by a one-dimensional diffraction grating.

FIG. 7(a) is a diagram illustrating that diffracted light 201 is distorted in the y-direction in the first embodiment. FIG. 7(b) is a diagram showing a configuration of an anamorphic prism which is used as an image distortion correcting section 15 in the first embodiment.

FIG. 8 is a diagram for illustrating an optical path of a light beam in wedge-shaped prisms which are components of the anamorphic prism.

FIG. 9 is a diagram illustrating that plane light beams of different incidence angles undergo Bragg diffraction in the first embodiment.

FIG. 10(a) is a concept diagram for illustrating an operation of a double diffraction optical system in the field of optics. FIG. 10(b) is a diagram illustrating that the acousto-optic imaging device of the first embodiment can be regarded as a double diffraction optical system.

FIG. 11(a) is a diagram showing the incidence direction of a plane wave light beam 14 in the first embodiment. FIG. 11(b) is a diagram showing another possible incidence direction.

FIG. 12 is a diagram showing a configuration of a cylindrical lens.

FIG. 13 is a diagram showing an optical system in the first embodiment, which is formed by cylindrical lenses and which has the functions of both the image distortion correcting section 15 and an image formation lens system 16.

FIG. 14 is a general configuration diagram showing the second embodiment of the acousto-optic imaging device of the present invention.

FIG. 15 is a schematic diagram specifically illustrating the second embodiment.

FIG. 16 is a diagram showing a configuration of an acoustic lens system 6 in the third embodiment.

FIG. 17 is a diagram showing a configuration of an image distortion correcting section 15 in the fourth embodiment.

FIG. 18 is a diagram showing a configuration of an image distortion correcting section 15 in the fifth embodiment.

FIG. 19 is a general configuration diagram showing the sixth embodiment of the acousto-optic imaging device of the present invention.

FIG. 20 is a schematic diagram showing a configuration of a device disclosed in Non-patent Document 1.

### DETAILED DESCRIPTION

The inventors of the present application examined the details of the object imaging technique disclosed in Non-patent Document 1. As a result, it was found that, according to the technique disclosed in Non-patent Document 1, only an image formation characteristic which is lower than the resolution that is determined according to the wavelength of an ultrasonic wave used is obtained.

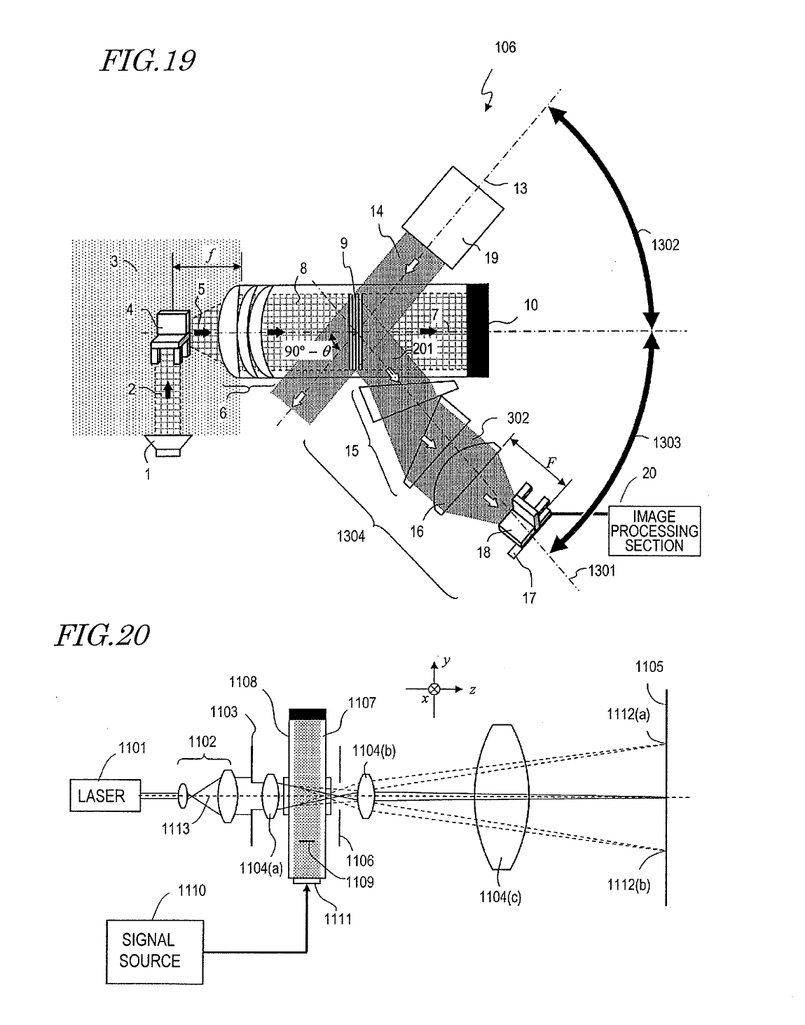

Specifically, since the real images of the object 1109 are the ±1st order diffraction images 1112(a), 1112(b), the real images are formed outside the optical axis of the optical system. In general, an image formation optical system (an optical system for formation of a real image) has greater coma aberration as it is more distant from the optical system, and therefore, it is difficult to form a real image of excellent image quality. Thus, in the configuration shown in FIG. 20, the image deteriorates due to coma aberration.

In Bragg diffraction, when the normal direction of the lattice plane is determined, the traveling directions of incoming light and diffracted light are uniquely determined. In the configuration shown in FIG. 20, at a single arbitrary point in a region of the water 1107 through which the monochromatic light beam passes, there is only one light beam traveling in a determined direction. There is a probability that diffracted light corresponding to all of the ultrasonic scattered waves derived from the object 1109 is not produced. According to the wavefront optics, a real image which has a resolution determined according to the lens aberration cannot be produced before all of the scattered waves arriving at the lens aperture contribute to image formation. Therefore, the resolution of a real image produced by the optical system of FIG. 20 is lower than a resolution which is determined in the context of wavefront optics.

It was also found that it has another problem when used as a practical imaging device in addition to the problem in the image formation characteristic. Specifically, according to the technique disclosed in Non-patent Document 1, the size of the configuration increases. In Non-patent Document 1, the propagation medium for ultrasonic waves is the water 1107. The propagation speed of ultrasonic waves is high in the water (about 1500 m/s), and therefore, even when an ultrasonic wave at 22 MHz, which is a high frequency disclosed in Non-patent Document 1, is used, the wavelength of the ultrasonic wave is about 68 μm. Thus, when the laser 1101 used is a light source at the wavelength of 633 nm which is disclosed in Non-patent Document 1, the diffraction angle of the ±1st order diffraction images 1112(a), 1112(b) is very small (about 0.27°). To achieve equal image magnification rates in the horizontal and vertical directions in FIG. 20, it is necessary to provide a large ratio between the focal lengths of two cylindrical lenses 1104(b) and 1104(c), and it is also necessary to separate the screen 1105 and the acoustic cell 1108 by about several meters.

According to the technique disclosed in Non-patent Document 1, it is necessary to immerse the object 1109 in a hermetic container which is filled with the water 1107. Further, since an ultrasonic scattered wave used for Bragg diffraction is a frontward scattered wave of the object 1109, it is difficult to image an object from the irradiation side of the acoustic wave.

In view of the above problems, the inventors of the present application conceived a novel acousto-optic imaging device. The summary of an embodiment of the present invention is as described below.

An acousto-optic imaging device which is one embodiment of the present invention includes: an acoustic wave source; an acoustic lens system for converting a scattered wave produced by irradiation of an object with an acoustic wave emitted from the acoustic wave source into a predetermined converged state; an acousto-optic medium section which is arranged such that a scattered wave transmitted through the acoustic lens system is incident on the acousto-optic medium section; a light source for emitting a light beam which is formed by a plurality of superposed monochromatic light rays traveling in different directions, the light beam being incident on the acousto-optic medium section at an angle which is neither perpendicular nor parallel to an acoustic axis of the acoustic lens system; an image formation lens system for condensing diffracted light of a plurality of the monochromatic plane wave light rays produced at the acousto-optic medium section; and an image receiving section for detecting light condensed by the image formation lens system to output an electric signal.

The acousto-optic imaging device may further includes an image distortion correcting section for correcting distortion in at least one of an image of the object which is represented by the diffracted light and an image of the object which is represented by the electric signal.

A spectral width of each of the monochromatic light rays may be less than 10 nm, and the monochromatic light ray may be a plane wave whose wavefront accuracy is not more than ten times a wavelength of the monochromatic light ray at its center frequency.

The acoustic lens system may be a refractive acoustic system.

The acoustic lens system may be formed by a silica nanoporous element or Fluorinert.

The acoustic lens system may include at least one refraction surface and an antireflection film provided on the at least one refraction surface for preventing reflection of an acoustic wave.

The acoustic lens system may be a reflective acoustic system.

The acoustic lens system may include two or more reflection surfaces.

The acoustic lens system may include a focal length adjusting mechanism.

The image formation lens system may include a focal point adjusting mechanism.

The light source may include fly-eye lenses.

The image distortion correcting section may include an optical member for magnifying a cross section of the diffracted light.

The image distortion correcting section may include an optical member for reducing a cross section of the diffracted light.

The optical member may be formed by an anamorphic prism.

At least one of the image formation lens system and the optical member may include at least one cylindrical lens.

The image distortion correcting section may perform image processing based on the electric signal.

The acousto-optic medium section may include at least one of a silica nanoporous element, Fluorinert, and water.

The diffracted light may include a component of Bragg diffracted light such that an intensity proportion of the Bragg diffracted light is not less than ½.

An optical axis of the light beam emitted from the light source is adjustable with respect to the acoustic axis of the acoustic lens system.

The acoustic wave may be a pulsed acoustic wave.

### First Embodiment

Hereinafter, the first embodiment of an acousto-optic imaging device of the present invention is described with reference to the drawings.

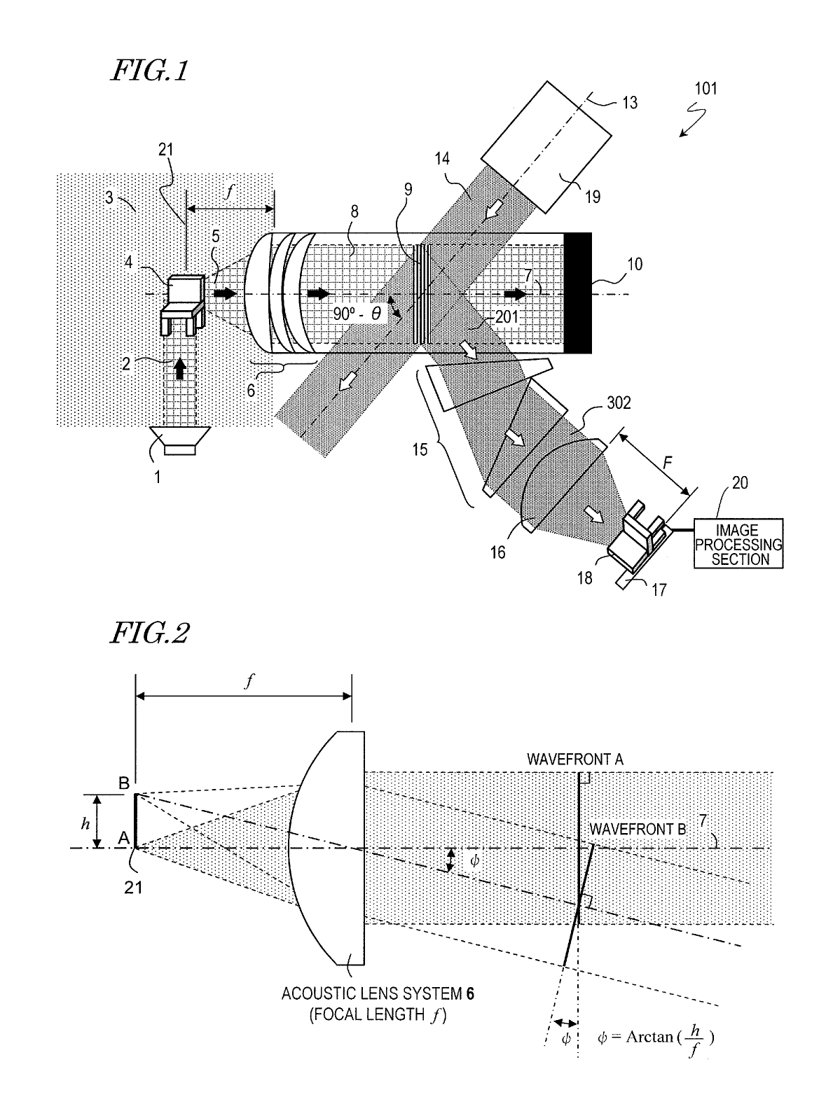

FIG. 1 schematically shows a configuration of an acousto-optic imaging device 101. The acousto-optic imaging device 101 includes an acoustic wave source 1, an acoustic lens system 6, an acousto-optic medium section 8, a light source 19, an image distortion correcting section 15, an image formation lens system 16, and an image receiving section 17.

An object 4 is placed in a medium 3 through which an acoustic wave can propagate. Examples of the medium 3 through which an acoustic wave can propagate include air, water, etc. Alternatively, the medium 3 may be a body tissue or an elastic element which is made of a metal, concrete, or the like. Note that, in FIG. 1 and the drawings which will be mentioned below, the object 4 is shown as a chair, although this is merely an example object which is easy to show. The size of an object which can be suitably imaged by the acousto-optic imaging devices of the present embodiment and embodiments which will be described later, or the size of an imaging region which can be imaged without moving the acoustic lens system 6, depends on a scattered wave converged by the acoustic lens system 6, the beam diameter of a light beam 14 emitted from the light source 19, the size of the acousto-optic medium section 8, etc., and may be determined according to the use of the acousto-optic imaging device. For example, in the acousto-optic imaging device of the present embodiment, in the case where the acoustic lens system 6 employed has a focal length of 100 mm and the light beam 14 used is a plane wave light beam which forms an angle of less than 15° with respect to the optical axis 13, the size of the imaging region on the object is about 5.4 cm in diameter. When the acoustic wave 2 used is at the frequency of 10 MHz, the resolution is about 0.15 mm. Also, as will be described as the second embodiment, the acousto-optic imaging device of the present invention is also suitable to an ultrasonographic device for observing internal body components.

The acoustic wave source 1 and the acoustic lens system 6 are provided in the medium 3 or provided so as to be in contact with the medium 3. The object 4 is irradiated with the acoustic wave 2 emitted from the acoustic wave source 1. The acoustic wave 2 is reflected at the surface of the object 4 and a region inside the object 4 in which the acoustic impedance (the product of sound velocity by density) is nonuniform, so that a scattered wave 5 is produced. The scattered wave 5 is converted by the acoustic lens system 6 into a predetermined converged state, particularly converted into a plane acoustic wave 9, which is then incident on the acousto-optic medium section 8. The plane acoustic wave 9 propagates through the acousto-optic medium section 8 so that a varying refractive index distribution is caused in the acousto-optic medium section 8. The plane wave light beam 14 emitted from the light source 19 is incident on the acousto-optic medium section 8 and is diffracted due to the refractive index distribution of the acousto-optic medium section 8, so that diffracted light outgoes from the acousto-optic medium section 8. This diffracted light is condensed by the image formation lens system 16 onto the image receiving section 17, whereby a real image 18 of the object 4 can be imaged. Hereinafter, respective components of the acousto-optic imaging device 101 are described in detail. Note that, strictly speaking, the real image 18 is an image which is similar to the two-dimensional distribution of the elastic modulus of the object 4 on a plane that is perpendicular to the acoustic axis 7 and that is distant from the acoustic lens system 6 by the focal length f of the acoustic lens system 6.

1. Configuration of the Acousto-Optic Imaging Device 101

(1) Acoustic Wave Source 1

The acoustic wave source 1 emits the acoustic wave toward the object 4. The acoustic wave 2 may be an ultrasonic wave. In the case where the object 4 is imaged one time, the acoustic wave 2 may be a pulse wave which includes a plurality of sine waves whose amplitude and frequency are constant. As the number of waves increases, the intensity of diffracted light produced in the acousto-optic medium section 8 increases. Thus, for example, the duration of the acoustic wave 2 is set to a value which is equal to or greater than the inverse of the frequency (period). The acoustic wave 2 may not be a plane wave. Although not shown in FIG. 1, the time of emission of the acoustic wave 2 by the acoustic wave source 1 is accurately controlled by a trigger circuit.

The acoustic wave 2 may be a plane wave or may not be a plane wave. Preferably, the acoustic wave 2 is emitted to irradiate the entirety of the object 4, or a portion of the object 4 which is to be imaged, with generally uniform intensity. That is, the acoustic wave 2 may have an irradiation cross section whose largeness is determined according to a region which is to be imaged. Here, “irradiate with generally uniform illumination intensity” means that the irradiation is carried out such that the acoustic pressure is uniformly applied onto an imaging region which is assumed as one of the specifications of the acousto-optic imaging device 101. The imaging region refers to a region in the vicinity of the object side focal point of the acoustic lens 6. For example, in the case where the imaging region is a region whose radius is 10 mm and which resides in the vicinity of the focal point, a region whose radius is 10 mm and which resides in the vicinity of the focal plane may be uniformly irradiated. The acoustic wave 2 is reflected and scattered at the surface of the object 4 and the inside of the object 4, so that a scattered wave 5 which has the same frequency as that of the acoustic wave 2 is produced.

(2) Acoustic Lens System 6

The acoustic lens system 6 causes the scattered wave 5 to converge to a predetermined state. Specifically, the acoustic lens system 6 has a focal length f in the medium 3. The acoustic lens system 6 may be a refractive acoustic system or may be a reflective acoustic system. When the acoustic lens system 6 is a refractive acoustic system, the acoustic lens system 6 has at least one refraction surface and includes acoustic lenses through which the scattered wave 5 is transmitted. The acoustic lenses may be formed by an elastic element whose propagation loss for the acoustic wave is small, such as a silica nanoporous element or Fluorinert. Refraction of the acoustic wave at the refraction surface occurs according to the Snell's law such that the scattered wave 5 is refracted at an angle which is determined based on the sound velocity ratio of the scattered wave 5 in the medium 3 and the material of the acoustic lenses. When the acoustic lens system 6 is a reflective acoustic system, the acoustic lens system 6 has at least one reflection surface which is made of a material whose acoustic impedance is greatly different from that of the medium 3, such as a metal, glass, and the like. These refraction and reflection surfaces each have the same shape as the optical lenses so that they can converge the scattered wave 5.

The refraction surface may be provided with an antireflection film which has the same function as that of an antireflection film which is usually provided in the field of optics for the purpose of reducing the reflection loss and stray light at a lens refraction surface. For example, the refraction surface may be provided with an antireflection film whose acoustic impedance is equal to the geometric mean value of the acoustic impedances of the medium 3 and the acoustic lenses and whose thickness is equal to ¼ of the wavelength (herein, the wavelength refers to a wavelength at the frequency of the sine waves that form the acoustic wave 2).

The object 4 may be positioned in the vicinity of the focal point of the acoustic lens system 6. The real image 18 of the object 4 is blurred as it deviates from a focal plane 21 of the acoustic lens system 6, as is the case with the optical imaging devices, such as optical cameras. Here, the focal plane 21 refers to a plane which is perpendicular to the acoustic axis 7 and which is distant from the acoustic lens system 6 in the direction to the object 4 by the focal length f of the acoustic lens system 6.

Thus, to obtain a sharp real image 18 of the object 4 which is out of the focal plane 21, the entirety of the acousto-optic imaging device 101 may be moved such that the object 4 occurs on the focal plane 21 of the acoustic lens system 6. When it is difficult to move the acousto-optic imaging device 101 in the direction of the acoustic axis 7 of the acoustic lens system 6, the acoustic lens system 6 may further include a focal point adjustment mechanism, such as those provided for imaging lenses of optical cameras. When it is also configured such that the size of the real image 18 relative to the object 4 is variable, any one or both of the acoustic lens system 6 and the image formation lens system 16 may be provided with a focal length adjustment function (i.e., zoom function).

For the sake of simplified discussion, when the object 4 is in the vicinity of the focal point of the acoustic lens system 6, it is assumed that the produced scattered wave 5 occurs on the focal plane 21 of the acoustic lens system 6. Since the scattered wave 5 is a spherical wave whose center is at an arbitrary point on the focal plane, the spherical wave is converted by the acoustic lens system 6 into an acoustic wave propagating in the acousto-optic medium section 8 which has a planar wavefront. Spherical waves occurring from respective points on the focal plane 21 are converted into such plane acoustic waves, and therefore, the scattered wave 5 which has passed through the acoustic lens system 6 changes to the plane acoustic wave 9 that is formed by superposed plane acoustic waves traveling in various directions. Now, consider a case where spherical waves occur at a point A and a point B on the focal plane 21 as shown in FIG. 2. Point A is the intersection of the acoustic axis 7 and the focal plane 21. Point B is on the focal plane 21 but is distant from the acoustic axis 7 by distance h. The spherical wave occurring at the point A is converted into a plane wave which has a planar wavefront A. Since the point A is on the acoustic axis 7, the normal line of the wavefront A is parallel to the acoustic axis 7. On the other hand, the spherical wave occurring at the point B is also converted into a plane wave which has a planar wavefront B. However, the normal line of the wavefront B forms an angle ψ with respect to the acoustic axis 7. As shown in FIG. 2, the angle ψ is equal to Arctan(h/f). Here, Arctan denotes an arctangent function. In actuality, a spherical wave occurs at every point between the point A and the point B, and therefore, the plane acoustic wave 9 shown in FIG. 1 is an acoustic wave that is formed by superposed plane waves, the normal lines of the wavefronts of which form various angles ψ with respect to the acoustic axis 7.

(3) Acousto-Optic Medium Section 8

The acousto-optic medium section 8 is formed by an isotropic elastic element which causes a small propagation loss for the acoustic wave 2 (scattered wave 5) that has a sinusoidal frequency and which is transparent to the light beam 14 that will be described later. Examples of such an elastic element which are preferably used include a nanoporous element which is made of dry silica gel, Fluorinert, and water. To improve the image quality (particularly, resolution) of the real image 18, using a transparent elastic element whose sound velocity is as slow as possible is desired, and using a silica nanoporous element or Fluorinert is preferred.

The acousto-optic medium section 8 may be arranged relative to the acoustic lens system 6 such that the plane acoustic wave 9 converted by the acoustic lens system 6 is incident on the acousto-optic medium section 8 with a small loss. Specifically, when the acoustic lens system 6 is a refractive acoustic system, the acousto-optic medium section is provided on the opposite side to the object 4 with respect to the acoustic lens 6. The acoustic lens system 6 may be joined to the acousto-optic medium section 8. To prevent a loss which can be caused by reflection at the joining surface, the joining surface may be provided with an antireflection film. When the acoustic lens system 6 and the acousto-optic medium section 8 are made of the same material, the acoustic lens system 6 may be provided on part of the acousto-optic medium section 8 (e.g., a surface bordering on the medium 3). As shown in FIG. 1, the plane acoustic wave 9 traveling in a direction parallel to the acoustic axis 7 propagates through the acousto-optic medium section 8, in a region including the acoustic axis 7, with the wavefront of the plane acoustic wave 9 being perpendicular to the acoustic axis 7 of the acoustic lens system 6. Thus, the acousto-optic medium section 8 includes the acoustic axis 7 of the acoustic lens system 6.

(4) Acoustic Wave Absorbing Section 10

When the plane acoustic wave 9 which has propagated through the acousto-optic medium section 8 is then reflected at the end of the acousto-optic medium section 8 and the reflected plane acoustic wave 9 affects detection of the plane acoustic wave 9, the end of the acousto-optic medium section 8 may be provided with an acoustic wave absorbing section 10. The acoustic wave absorbing section 10 absorbs, or attenuates, the plane acoustic wave 9 without causing reflection or scattering. The acoustic wave absorbing section 10 absorbs all of acoustic waves arriving at the acoustic wave absorbing section 10, and therefore, acoustic waves which are present in the acousto-optic medium section 8 include only the plane acoustic wave 9 that propagates in one direction. This arrangement enables to prevent detection of reflection of the plane acoustic wave 9 as a noise and hence deterioration of the image quality of an image of the object 4.

At least one of the boundaries between the acousto-optic medium section 8, the acoustic lens system 6, and the acoustic wave absorbing section 10 may be provided with an acoustic matching layer. Provision of the acoustic matching layer can reduce the effects of reflection waves which can occur at the interfaces where these components are in contact with one another. A reflection wave which can occur at the refraction surface of the acoustic lens system 6 causes reduction of transmitted light and thus can be a cause of the decrease in luminance of the image 18. Reflection waves produced at the refraction surface of the acoustic lens system 6, the interface between the acoustic wave absorbing section 10 and the acousto-optic medium 8, and an end face of the acousto-optic medium 8 which is not in contact with the acoustic wave absorbing section 10 can be a cause of deterioration in the image quality of the image 18. These reflection waves correspond to stray light in the field of optics and do not contribute to image formation. Increase of these reflection waves can cause deterioration in the S/N ratio of the image, decrease in contrast, and superposition (ghost) of an image other than the image of the object 4 that is to be imaged. Major components of these reflection waves are a component produced at the refraction surface of the acoustic lens 6 and a component produced at a surface of the acousto-optic medium 8 which is in contact with the acoustic wave absorbing section 10. Therefore, an acoustic matching layer may be provided between the aforementioned three components to prevent occurrence of reflection waves which can be caused by these three components.

(5) Light Source 19

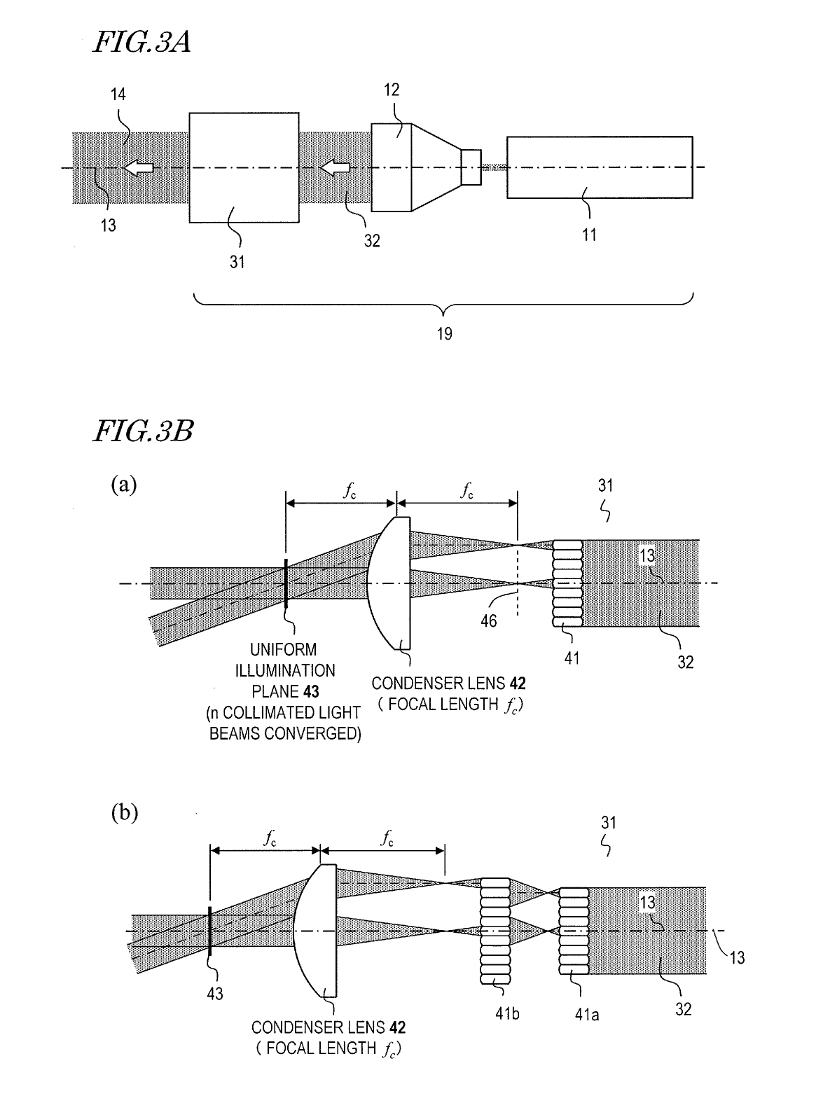

The light source 19 emits the light beam 14 that is a plane wave formed by a plurality of superposed monochromatic light rays traveling in different directions as described above. The light source 19 is arranged relative to the acousto-optic medium section 8 such that the light beam 14 is incident on the acousto-optic medium section 8 at an angle which is neither perpendicular nor parallel to the acoustic axis 7 of the acoustic lens system 6. Respective ones of the plurality of superposed monochromatic light rays that form the light beam 14 are plane wave light beams of the same wavelength, which have equal wavelengths and equal phases, except for the traveling directions. As shown in FIG. 3A, for example, the light source 19 includes a monochromatic light source 11, a beam expander 12, and a uniform illumination optical system 31.

The monochromatic light source 11 produces a highly coherent light beam which is parallel to the optical axis 13. That is, light rays in the light beam have equal wavelengths and equal phases. Specifically, the spectral width (half-value width) of a light beam emitted by the monochromatic light source 11 may be less than 10 nm.

The monochromatic light source 11 used may be, for example, a gas laser, which is typified by a He—Ne laser, a solid-state laser, a semiconductor laser which is narrow-banded by an external resonator, or the like. The monochromatic light source 11 may continuously emit a light beam or may emit a pulsed light beam. The wavelength of the light beam emitted from the monochromatic light source 11 may be within such a wavelength band that the propagation loss is small in the acousto-optic medium section 8. For example, when the acousto-optic medium section 8 used is a silica nanoporous element, a laser which has a wavelength of not less than 600 nm may be used as the monochromatic light source 11.

The beam expander 12 increases the beam diameter of the light beam emitted from the monochromatic light source 11 and emits a plane wave light beam 32 with the increased beam diameter. In the beam expander 12, the beam diameter is increased, but the wavefront state of the light beam is maintained. Thus, the light beam which has passed through the beam expander 12 is also a plane wave.

FIG. 3B(a) is a schematic diagram showing the configuration of the uniform illumination optical system 31. The uniform illumination optical system 31 includes a fly-eye lens 41 and a condenser lens 42. The fly-eye lens 41 is formed by a plurality of simple lenses which are in a two-dimensional arrangement. Each of the simple lenses has an optical axis which is parallel to the optical axis 13 of the plane wave light beam 32. The focal points of respective ones of the simple lenses are all on a focal plane 46 which is a flat plane perpendicular to the optical axis 13. Respective ones of the simple lenses may have different aperture shapes and different aperture diameters. The focal length of the fly-eye lens 41 may be different. In this case, the position of each fly-eye lens 41 may be moved parallel to the optical axis 13 such that the focal point is coincident with the focal plane 46. The condenser lens 42 has focal length fc. The optical axis of the condenser lens 42 is parallel to the optical axis 13 of the plane wave light beam 32. The condenser lens 42 is placed at a position which is distant from the focal plane 46 by distance fc. The optical axis of the condenser lens 42 is coincident with the optical axis 13 of the plane wave light beam 32.

When the plane wave light beam 32 is incident on the fly-eye lens 41, the plane wave light beam 32 is split, and spots of light condensed by the respective simple lenses are formed on the focal plane 46. When the fly-eye lens 41 has n simple lenses, the total number of spots is n. The n light beams converged on the focal plane 46 are spherical wave light beams whose centers are the spots on the focal plane 46 and which travel toward the condenser lens 42. Since the focal plane 46 is also a focal plane of the condenser lens 42, the condenser lens 42 converts the respective spherical wave light beams into plane wave light beams. However, spots on the focal plane 46 which are derived from the simple lenses other than one that is on the optical axis 13 are shifted parallel from the optical axis 13, and therefore, plane wave light beams which are derived from the simple lenses other than one that is on the optical axis 13 outgo from the condenser lens 42 obliquely relative to the optical axis 13 such that they traverse the optical axis 13 on a plane which is distant by distance fc. That is, the plane wave light beams produced by the simple lens travel to the focal point of the condenser lens 42. Thus, n plane wave light beams, whose number is equal to the number of simple lenses, are incident at various angles and converge on the focal point. A plane which includes this focal point and which is perpendicular to the optical axis 13 is hereinafter referred to as “uniform illumination plane 43”. The n plane wave light beams superposed on the uniform illumination plane 43 may have a wavefront accuracy which is not more than ten times the wavelength at the center frequency of monochromatic light emitted from the monochromatic light source 11.

The fact that a plurality of plane wave light beams illuminate the uniform illumination plane 43 at different angles means that a large number of light rays at different angles are incident on a point at any position on the uniform illumination plane 43. A significant condition for the acousto-optic imaging device 101 to image the object 4 with high resolution over a wide area is to use a light beam which is formed by a plurality of superposed monochromatic light rays traveling in different directions. The reasons for that will be described in detail in the section devoted to the description of the operation of the acousto-optic imaging device 101.

As shown in FIG. 5, in the acousto-optic medium section 8 of the acousto-optic imaging device 101, the uniform illumination plane 43 may irradiate the entirety of the plane acoustic wave 9 propagating through the acousto-optic medium section 8. This configuration enables plane wave light beams to impinge at various incidence angles on the plane acoustic wave 9 propagating through the acousto-optic medium section 8 or on the entirety of a region of the acousto-optic medium 8 in which a varying refractive index distribution is caused by the plane acoustic wave 9, so that a real image 18 of high luminance and high quality can be formed from the entire imaging region over the object 4. Therefore, the area of the cross section of the plane wave light beam 14 shown in FIG. 1 may be greater than the area of the cross section of a region of the acousto-optic medium section 8 through which the plane acoustic wave 9 propagates.

In the case where plane wave light beams are superposed on the uniform illumination plane 43 at greater incidence angles (here, the incidence angle refers to an angle between the optical axis 13 and the traveling direction of a plane wave light beam derived from each simple lens), the condenser lens 42 used may be a lens with a smaller F-number (F-number=focal length/lens aperture diameter). When the object 4 is imaged over a wider range, a plane acoustic wave which is more inclined with respect to the acoustic axis 7 is produced as shown in FIG. 2. To produce Bragg diffracted light based on such a plane acoustic wave, it is preferred to use a plane wave light beam with a greater incidence angle. Therefore, using the condenser lens 42 with a small F-number enables imaging of the object 4 over a wide range.

In the case where a greater number of plane waves at different incidence angles are superposed on the uniform illumination plane 43, the fly-eye lens may have a multi-stage configuration as shown in FIG. 3B(b). As shown in FIG. 3B(b), a plane wave light beam 32 emitted from a monochromatic light source may be transmitted through a fly-eye lens 41a and a fly-eye lens 41b before impinging on the condenser lens 42. In the optical system shown as an example in FIG. 3B(b), a light beam produced by a single simple lens of the fly-eye lens 41a is converted by the fly-eye lens 41b into three light beams. Therefore, a number of plane wave light beams, whose number is equal to three times the number of small lenses that form a fly-eye lens 45, are incident on the uniform illumination plane 43 at different angles.

The uniform illumination optical system 31 not only functions to produce a group of light beams at different incidence angles but also functions as an optical system for producing a light beam which has a uniform illumination distribution. The light intensity distribution across a light beam cross section of the plane wave light beam 32 produced by the optical system of FIG. 3A has a shape of a Gaussian distribution which has generally rotational symmetry about the optical axis 13. However, thanks to the function of the uniform illumination optical system 31, a generally uniform light intensity distribution is achieved across the uniform illumination plane 43.

What are projected on the uniform illumination plane 43 are light beams which are incident on, and then magnified by, respective ones of the simple lenses that form the fly-eye lens 41. In the case where simple lenses which have sufficiently small apertures are used for the fly-eye lens, a light beam which is incident on each simple lens has a generally uniform light intensity distribution even when the plane wave light beam 32 has a varying light intensity distribution, because the aperture of each simple lens is small. Since such light beams are magnified and superposed on the uniform illumination plane 43, the light intensity distribution is generally uniform across the uniform illumination plane 43. Note that as the aperture of each simple lens is decreased relative to the light beam diameter of the plane wave light beam 32, or as the number of stages is increased in the multi-stage configuration of the fly-eye lens, the illumination intensity distribution becomes more flat across the uniform illumination plane 43. Flattening of the illumination intensity distribution is effective for formation of the real image 18 without uneven illumination intensity.

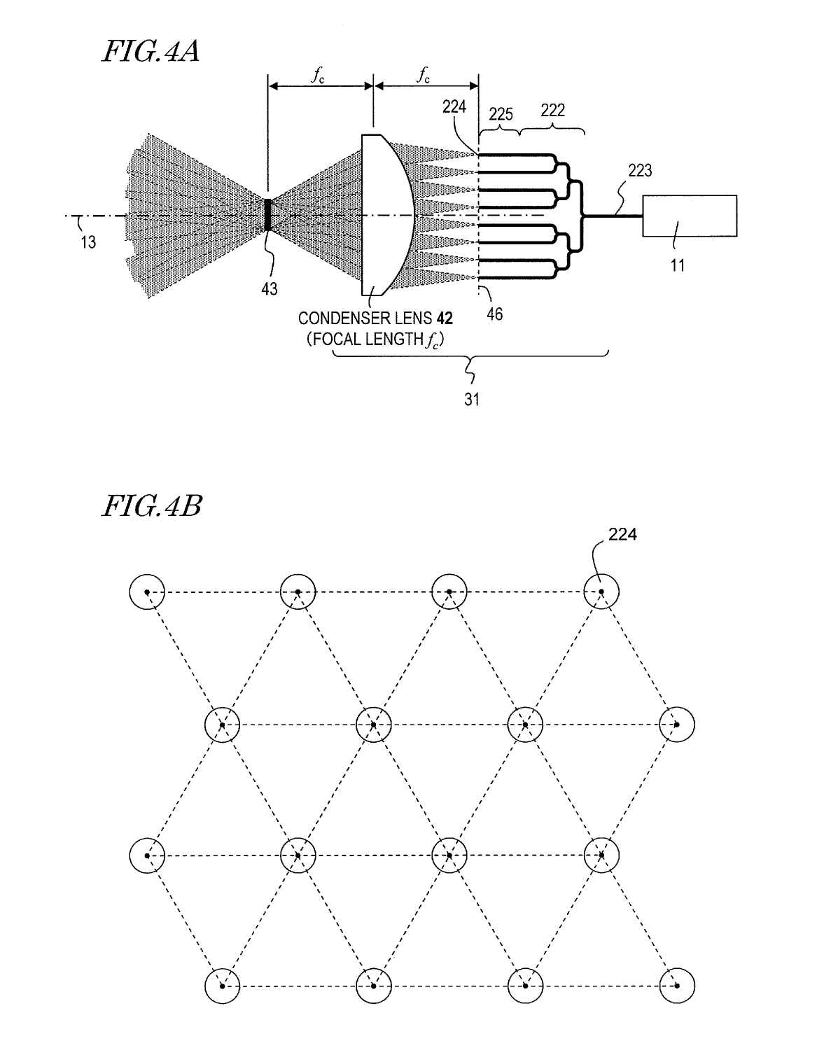

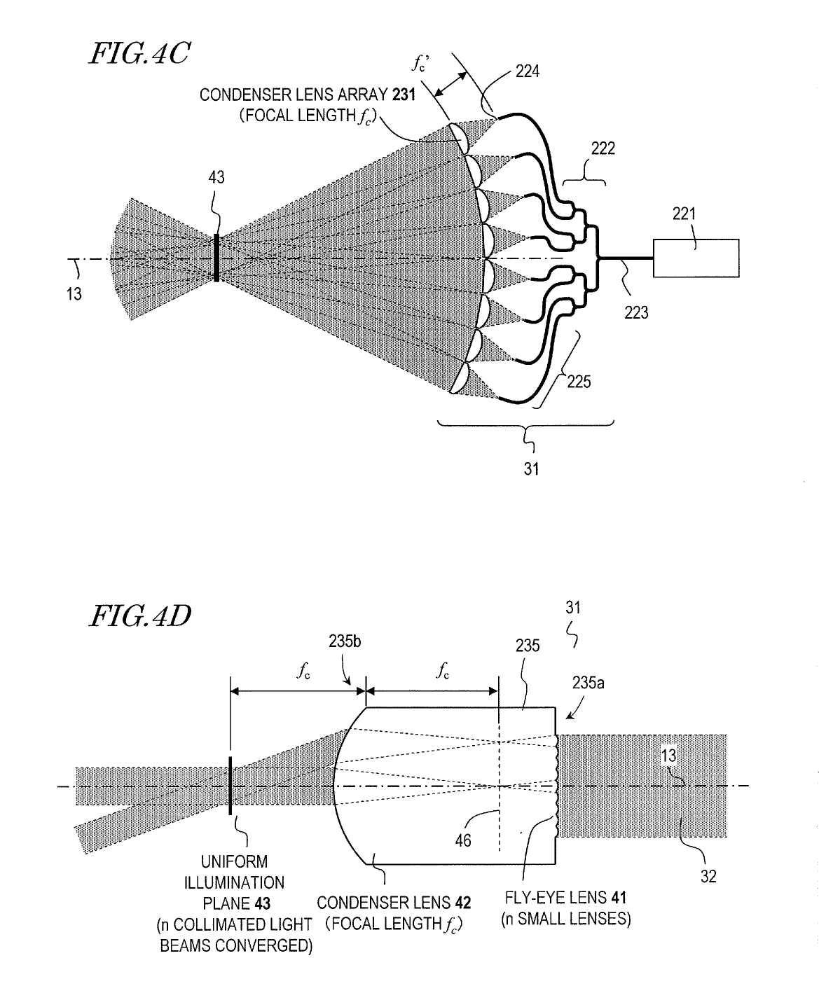

The uniform illumination optical system 31 may be realized by a different configuration. The uniform illumination optical system 31 shown in FIG. 4A includes a single mode optical fiber 223, a plurality of single mode optical fibers 225, an optical fiber coupler array 222 for optically coupling the single mode optical fiber 223 and the plurality of single mode optical fibers 225, and a condenser lens 42. A highly coherent plane wave light beam emitted from the monochromatic light source 11 that includes a semiconductor laser, etc., is guided to the single mode optical fiber 223. The optical fiber coupler array 222 is optically connected to one end of the single mode optical fiber 223. The plane wave light beam which has entered the single mode optical fiber 223 then enters the connected optical fiber coupler array 222 so as to be split into plane wave light beams which propagate through the plurality of single mode optical fibers 225. At this point, the light beams propagating through the plurality of single mode optical fibers 225 have generally equal amounts. Such equal apportioning of the light amount may be realized by using, for example, a trifurcated optical fiber coupler for equally apportioning the light amount (i.e., 3 dB optical fiber coupler) as the optical fiber coupler array 222. The optical fiber coupler array 222 used may be a single-input/multi-branch type light amount equally apportioning optical fiber coupler or a light amount equally apportioning single-input/multi-branch type optical waveguide. In the case where branching by the optical waveguide is employed, a path conversion section may be inserted between the single mode optical fiber and the optical waveguide. For example, a micro moving mechanism may be used for adjusting the position of the optical waveguide or optical fiber such that the end face of the optical waveguide and the end face of the optical fiber are close to each other by a distance of less than one wavelength, and the optical axis of the optical waveguide is coincident with the optical axis of the optical fiber. Further, the path conversion section used may be a prism.

The end faces 224 of the single mode optical fibers 225 are two-dimensionally arranged on the focal plane 46 of the condenser lens 42. FIG. 4B shows the arrangement of the end faces 224 on the focal plane 46. The end faces 224 are in a triangular lattice arrangement as shown in FIG. 4B, for example. The lattice pitch of the triangular lattice is selected such that real images 18 which are formed on the image receiving section 17 by light beams emitted from the end faces 224 of the respective optical fibers are superposed with an appropriate overlap. The end faces 224 may be in an arrangement which is different from the triangular lattice arrangement, for example, a square lattice arrangement.

The orientation of each of the single mode optical fibers 225 is adjusted such that the central axis of the light beam emitted from the end face 224 of the optical fiber is parallel to the optical axis 13. The respective light beams which have passed through the condenser lens 42 are converged to a point on the uniform illumination plane 43 that is distant by the focal length, at which the optical axis 13 intersects with the uniform illumination plane 43, as previously described with reference to FIG. 4A. Therefore, a state is realized in which a large number of light rays incoming at different angles are incident on a point at an arbitrary position on the uniform illumination plane 43.

The uniform illumination optical system 31 shown in FIG. 4C includes a single mode optical fiber 223, a plurality of single mode optical fibers 225, an optical fiber coupler array 222 for optically coupling the single mode optical fiber 223 and the plurality of single mode optical fibers 225, and a condenser lens array 231.

The configuration of the single mode optical fiber 223, the plurality of single mode optical fibers 225, and the optical fiber coupler array 222 is the same as the embodiment of FIG. 4A.

The condenser lens array 231 is formed by a plurality of minute condenser lenses which have focal length fc′ and which are in a two-dimensional arrangement. Each of the plurality of minute condenser lenses is placed at a position which is distant from the end face 224 of the single mode optical fiber 225 by a distance of focal length fc′. With this configuration, light beams emitted from the respective single mode optical fibers 225 are converted by the minute condenser lenses into collimated light beams. Further, thanks to the arrangement of the minute condenser lenses, light beams outgoing from the minute condenser lenses are converged to a point on the uniform illumination plane 43 at which the optical axis 13 intersects with the uniform illumination plane 43. Therefore, a state is realized in which a large number of light rays incoming at different angles are incident on a point at an arbitrary position on the uniform illumination plane 43.

The uniform illumination optical system 31 shown in FIG. 4D includes an optical element 235 which has the above-described functions of the condenser lens and fly-eye lens. The optical element 235 has an optical surface 235a and an optical surface 235b. The optical surface 235a is formed by a fly-eye lens surface that includes a plurality of simple lens surfaces. The optical surface 235b is formed by a condenser lens surface. The focal length of the condenser lens surface is fc. The optical element 235 is designed such that the position of the focal point of the condenser lens surface is coincident with the focal plane 46 on which the positions of the focal points of the respective simple lens surfaces of the fly-eye lens surface occur.

The uniform illumination optical system 31 shown in FIG. 4D functions in the same way as the uniform illumination optical system 31 shown in FIG. 4A so that the respective light beams outgoing from the condenser lens surface 235b are converged to a point on the uniform illumination plane 43 that is distant by the focal length, at which the optical axis 13 intersects with the uniform illumination plane 43, as previously described with reference to FIG. 4A. Therefore, a state is realized in which a large number of light rays incoming at different angles are incident on a point at an arbitrary position on the uniform illumination plane 43. The uniform illumination optical system 31 that has the form shown in FIG. 4D can advantageously be formed by a single optical element. For example, the optical element 235 can be manufactured by press molding with the use of a low-melting glass material, although the shape of the optical element 235 is complicated as compared with simple lenses.

2. Operation of the Acousto-Optic Imaging Device 101

Next, the operation of the acousto-optic imaging device 101 is described.

As shown in FIG. 1, an acoustic wave source 1 emits an acoustic wave 2 which has the above-described waveform toward the object 4. The acoustic wave 2 is reflected or scattered by the object 4 so that a scattered wave 5 is produced. The produced scattered wave 5 is converted by the acoustic lens system 6 into a plane acoustic wave 9, which then propagates through the acousto-optic medium section 8.

As described above, the plane wave light beam 14 consists of a large number of plane wave light beams traveling in different direction. The plane acoustic wave 9 also consists of a large number of plane acoustic waves traveling in different direction. However, herein, the operation of the acousto-optic imaging device 101 is described on the assumptions that the plane wave light beam 14 consists only of a plane wave light beam whose wavefront is perpendicular to the optical axis 13, and the plane acoustic wave 9 consists only of a plane acoustic wave which is perpendicular to the acoustic axis 7.

The plane wave light beam 14 comes in obliquely to the acoustic axis 7 of the acoustic lens system 6. The optical axis 13 of the plane wave light beam 14 forms angle θ with respect to the wavefront of the plane wave light beam 14 (i.e., the incidence angle of the plane wave light beam 14 onto the wavefront of the plane acoustic wave 9 is θ). The angle between the acoustic axis 7 and the optical axis 13 of the light beam 14 emitted from the light source 19 is 90°−θ. The angle θ may be any angle except for 0°, 90°, 180°, and 270°. At this angle θ, the plane wave light beam 14 undergoes Bragg diffraction so that diffracted light 201 is produced. The angle θ which leads to production of the diffracted light 201 will be described later.

As described above, in the acousto-optic imaging device 101, the time of emission of the acoustic wave 2 is accurately controlled. At the time of imaging in the image receiving section 17, the plane acoustic wave 9 precisely arrives at the intersection of the optical axis 13 and the acoustic axis 7. Specifically, for example, when the emission interval of the acoustic wave 2 is controlled with a time accuracy of 1 ns, the position error of the plane acoustic wave 9 which propagates through the acousto-optic medium section 8 with a sound velocity of 50 m/s is 50 nm. In the case where the monochromatic light source 11 used is a He—Ne laser, for example, this position error corresponds to a position error of 0.079 times the wavelength when converted to the wavelength of the He—Ne laser, 633 nm. Therefore, by adjusting the time of emission of the acoustic wave 2, the position of the plane acoustic wave 9 in the acousto-optic medium section 8 can be controlled with high accuracy.

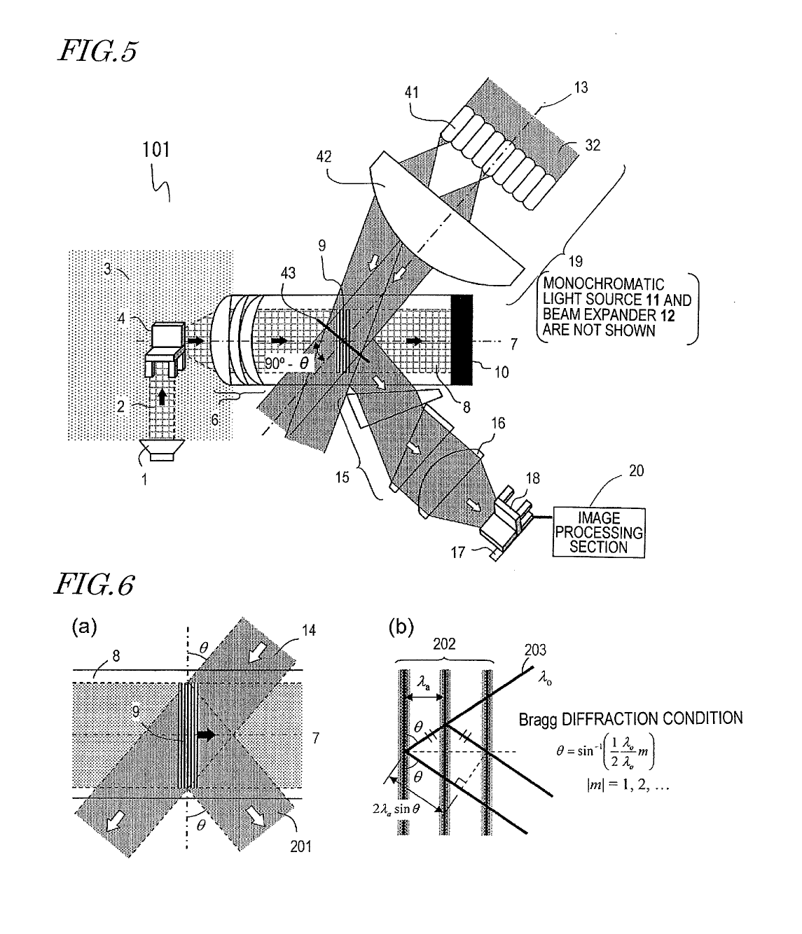

FIG. 6(a) schematically illustrates Bragg diffraction of the plane wave light beam 14 which is caused by the plane acoustic wave 9 at the moment when the plane acoustic wave 9 traverses the optical path of the plane wave light beam 14. The plane acoustic wave 9 is a compressional elastic wave which propagates through the acousto-optic medium section 8. Therefore, a refractive index distribution which is proportional to the acoustic pressure distribution of the plane acoustic wave 9 is caused in the acousto-optic medium section 8. Since the acoustic wave 2 is formed by a sine wave which has a single frequency as described above, the scattered wave 5 and the plane acoustic wave 9 are also sine waves which have single frequencies. Thus, the refractive index distribution caused in the acousto-optic medium section 8 has such a periodic structure that the period along the direction parallel to the acoustic axis 7 is equal to the wavelength of the plane acoustic wave 9 and the largeness of the refractive index varies in the shape of a sine wave, while it is uniform along the direction perpendicular to the acoustic axis 7.

The above-described refractive index distribution functions as a one-dimensional diffraction grating for the plane wave light beam 14. Therefore, when the plane wave light beam 14 is incident on the plane acoustic wave 9 at angle θ which satisfies the diffraction condition that is described below, the diffracted light 201 is produced. This one-dimensional diffraction grating has a flat grating plane, while the wavefront of the plane wave light beam 14 is flat, so that the diffracted light 201 is a plane wave light beam.

In the acousto-optic imaging device 101, the acoustic wave 2 consists of a sufficiently larger number of sine waves than the two periods, and therefore, repetition of the sparseness and denseness in the refractive index distribution is not less than two. Therefore, the refractive index distribution caused in the acousto-optic medium section 8 can be regarded as a one-dimensional diffraction grating, so that the plane wave light beam 14 is diffracted by Bragg diffraction. In the Bragg diffraction, as shown in FIG. 6(a), the angles which are formed by the plane wave light beam 14 and the diffracted light 201 with respect to the plane acoustic wave 9 are equal to each other, each of which is angle θ. The angle θ has a discrete value which satisfies the Bragg diffraction condition that is described below. In the case where the acoustic wave 2 consists of a small number of sine waves which are about two periods, the diffracted light 201 is mainly produced by Raman-Nath diffraction. Pure Raman-Nath diffraction can occur even when the angles which are formed by the plane wave light beam 204 and the diffracted light 201 with respect to the wavefront of the plane acoustic wave 9 are not equal to each other.

The diffracted light 201 produced by Bragg diffraction has a greater intensity than that produced by Raman-Nath diffraction, and therefore, the scattered wave 5 with a smaller acoustic pressure can be observed, contributing to improvement in sensitivity. Thus, in the acousto-optic imaging device 101, the diffracted light 201 may be used which is mainly produced by Bragg diffraction, with the use of the acoustic wave 2 that is formed by a sine wave with a large wavenumber. In actual imaging, the acoustic wave 2 used is formed by a sine wave which includes less than several tens of waves, and therefore, the diffracted light 201 includes Raman-Nath diffracted light. As will be described later, inclusion of the Raman-Nath diffracted light in the diffracted light 201 advantageously affects formation of an excellent real image 18.

The Bragg diffraction condition in the one-dimensional diffraction grating that is realized by the refractive index distribution that is caused by the plane acoustic wave 9 is described. As shown in FIG. 6(b), the grating pitch of a diffraction grating 202 that is generated by the plane acoustic wave 9 is equal to the wavelength λₐ of the plane acoustic wave 9 propagating through the acousto-optic medium section 8. One of the monochromatic light rays included in the plane wave light beam 14 is referred to as “monochromatic light 203”. The wavelength of the monochromatic light 203 is λo. When the monochromatic light 203 is incident on the diffraction grating 202, weak scattered light is produced at each grating stripe. Considering scattered light from adjacent grating planes, the optical path length difference between two light rays which are scattered in the same direction by the respective grating planes (2×λa×sin θ) is equal to an integral multiple of the wavelength λo (m×λ0, m=±1, ±2, . . . ), the two scattered light rays increase each other's intensities. This mutual increase of the intensities also occurs at the other grating planes so that, as a whole, scattered light with high intensity, i.e., diffracted light, is produced. For the reasons described hereinabove, the angle θ at which the diffracted light can be observed is expressed by formula (1):

$$\begin{matrix}[ Expression 1 ] & \\ θ = {sin}^{- 1} ( \frac{{λ}_{O} / {λ}_{a}}{2 \times m} ) , \\ ( m = \pm 1 , \pm 2 , … ) & ( 1 )\end{matrix}$$

Formula (1) is the condition for Bragg diffraction, which defines angle θ of the incoming light ray and the outgoing light ray with respect to the grating plane. sin⁻¹ represents an inverse sine function. Pure Bragg diffraction refers to a diffraction phenomenon which occurs when the diffraction grating 202 is formed by an infinite number of grating planes. As shown in FIG. 6(b), the angles of the incoming light ray and the outgoing light ray with respect to the grating plane are equal to each other, which are 6. In the Bragg diffraction, in general, the intensity of the resultant diffracted light 201 is higher as the degree m decreases. Therefore, to observe weaker scattered wave 5, the diffracted light 201 of m=±1 may be used. In the acousto-optic imaging device shown in FIG. 1, the diffracted light 201 shown is diffracted light of m=+1, although an acousto-optic imaging device which uses diffracted light of m=−1 may be realized.

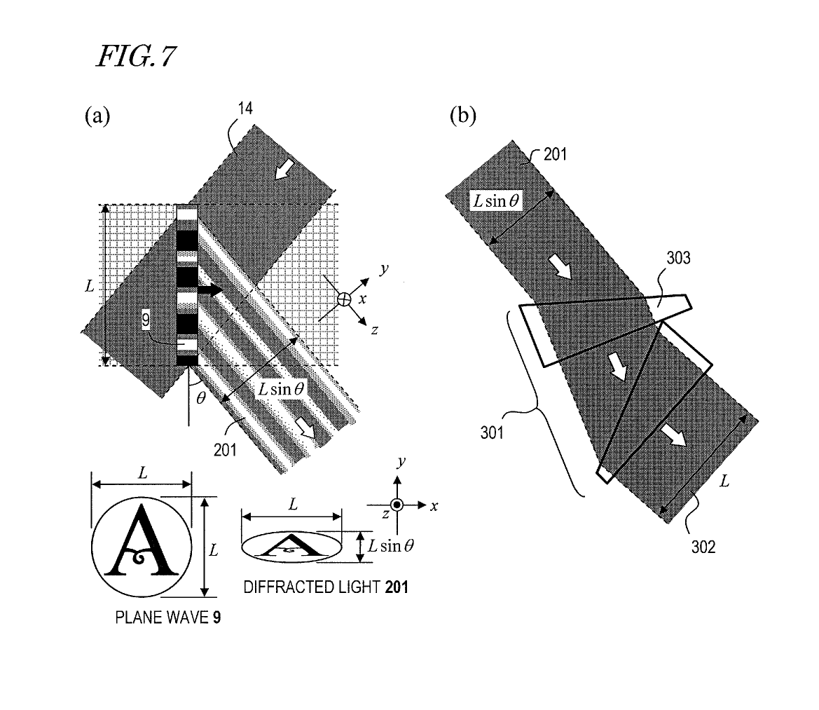

The diffracted light 201 enters the image distortion correcting section 15. The operation of the image distortion correcting section 15 is described with reference to FIG. 7(a). FIG. 7(a) is a schematic diagram illustrating contraction of the diffracted light 201 in one direction in the acousto-optic imaging device 101. As seen from formula (1), to meet the diffraction condition, the plane wave light beam 14 needs to be obliquely incident on the plane acoustic wave 9. Here, the beam shape of the plane acoustic wave 9 is a circle with diameter L, and the diffraction angle of the diffracted light 201 is θ (the definition of θ is the same as the above description). As described above, the plane wave light beam 14 has a beam diameter which encloses the plane acoustic wave 9, and the diffracted light 201 is produced only in a region where there is the plane acoustic wave 9. For these reasons, the beam shape of the diffracted light 201 is an elliptical shape in which the minor axis length along the y-axis is L×sin θ and the major axis length along the x-axis direction is L in the coordinate system shown in FIG. 7(a). That is, the optical amplitude distribution across the wavefront of the diffracted light 201 is proportional to a distribution which is obtained by multiplying the acoustic pressure distribution across the wavefront of the plane acoustic wave 9 by a factor of sin θ along the y-axis.

Thus, when the diffracted light 201 itself is subjected to image formation by means of the image formation lens system 16 such that the real image 18 is formed, the real image 18 is an optical image which is distorted along the y-axis, so that the similarity between the object 4 and the real image 18 is lost. In view of such, the image distortion correcting section 15 is used to correct the distortion of the diffracted light 201.

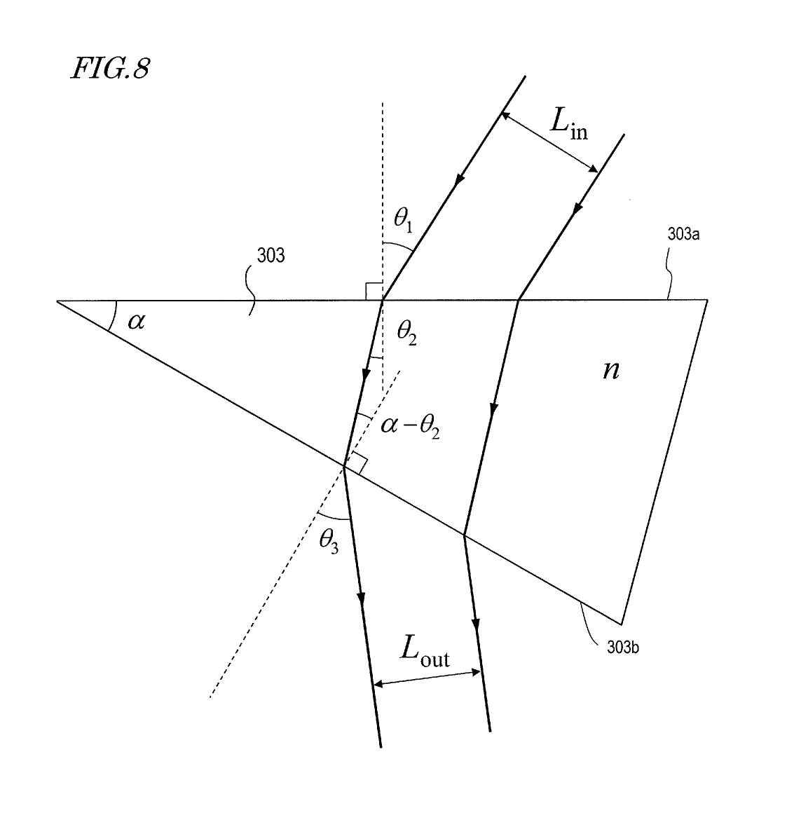

In the present embodiment, the image distortion correcting section 15 is formed by an anamorphic prism 301. FIG. 7(b) is a schematic diagram which illustrates the configuration and function of the anamorphic prism 301. As shown in FIG. 7(b), the anamorphic prism 301 includes two wedge-shaped prisms 303. The function of the wedge-shaped prisms 303 is described with reference to FIG. 8. FIG. 8 is a ray tracing diagram illustrating transmission of a light ray through the wedge-shaped prism 303. The wedge-shaped prism 303 is made of a material of refractive index n which is transparent to the diffracted light 201 and has two flat surfaces 303a, 303b. The angle between the flat surface 303a and the flat surface 303b is a, and the angle at which the light beam is incident on the flat surface 303a and the angle at which the light beam departs from the flat surface 303a with respect to the normal line of the flat surface 303a are θ₁ and θ₂, respectively. The angle at which the light beam outgoes from the flat surface 303b with respect to the normal line of the flat surface 303b is θ₃. The width of the light beam that is incident on the flat surface 303a and the width of the light beam that outgoes from the flat surface 303b in a plane including the normal lines of the two flat surfaces 303a, 303b are Lin and Lout, respectively. Here, the relationship of formula (2) holds true:

[Expression 2]

sin θ₁=n×sin θ₂

n×sin(α−θ₂)=sin θ₃ (2)

The beam diameter of the incident light beam and the beam diameter of the light beam outgoing from the wedge-shaped prism 303 in a plane including the normal lines of the two flat surfaces 303a, 303b are different. The light beam magnification rate, which is calculated by Lout/Lin, is represented by formula (3):

$$\begin{matrix}[ Expression 3 ] & \\ \frac{{L}_{out}}{{L}_{i n}} = \sqrt{\frac{{n}^{2} + ( {n}^{2} - 1 ) {tan}^{2} {θ}_{1}}{{n}^{2} + ( {n}^{2} - 1 ) {tan}^{2} {θ}_{3}}} & ( 3 )\end{matrix}$$

As seen from formulae (2) and (3), a desired light beam magnification rate can be achieved by appropriately selecting α, n, and angle θ₁ of the wedge-shaped prisms 303. The light beam magnification rate does not vary along a direction perpendicular to a plane including the normal lines of the two flat surfaces 303a, 303b irrespective of a, n, and angle θ₁. Therefore, when the wedge-shaped prisms 303 are used, the width along the y-axis direction of the diffracted light 201 shown in FIG. 7(a) can be adjusted.

As shown in FIG. 7(b), the anamorphic prism 301 can be formed by a combination of one or more pieces of the wedge-shaped prism 303 shown in FIG. 8. When two wedge-shaped prisms 303 which have equal shapes are used as shown in FIG. 7(b), the incoming light and outgoing light of the anamorphic prism 301 can be parallel to each other, enabling easy adjustment of the optical system.

As described above, the anamorphic prism 301 operates as a magnification optical system for magnifying the beam diameter of the light beam. In the acousto-optic imaging device 101, a, n, and incidence angle θ₁ of the wedge-shaped prisms 303 are selected, and the light beam of the diffracted light 201 is magnified along the y-axis direction by a factor of 1/sin θ as shown in FIG. 7(b). As a result, distortion-corrected diffracted light 302 is obtained which has a circular light beam cross section with diameter L. Therefore, the distortion-corrected diffracted light 302 has, on its wavefront, an optical amplitude distribution which is proportional to the acoustic pressure distribution across the wavefront of the plane acoustic wave 9. That is, the distortion-corrected diffracted light 302 has an optical amplitude distribution which is a reproduction of the entire acoustic pressure distribution across the wavefront of the plane acoustic wave 9, although its wavelength is different from that of the plane acoustic wave 9. Thus, a real image 18 which is similar to the object 4 can be produced.

As shown in FIG. 1, the distortion-corrected diffracted light 302 is condensed by the image formation lens system 16 that has focal length F. Since the distortion-corrected diffracted light 302 is a collimated light beam, the diffracted light 302 is condensed on a plane which is on the optical axis of the image formation lens system 16, which is distant from the image formation lens system 16 by a distance of length F, and which is perpendicular to the optical axis (focal plane), whereby the real image 18 is formed. The image receiving section 17 is provided at this position such that the real image 18 can be converted into an electric signal. The image receiving section 17 is typically a solid state image sensor, such as COD, CMOS, or the like, for imaging the light intensity distribution in the vicinity of the focal point of the image formation lens system 16 as an optical image and converting it into an electric signal. The image receiving section 17 is not limited to a solid state image sensor so long as it can receive an optical image formed on its imaging plane as image data. For example, the image receiving section 17 may be a photographic film.

An image processing section 20 carries out image processing based on the electric signal input from the image receiving section 17 to produce the real image 18. In this way, the acousto-optic imaging device can image the object 4.

In the description provided hereinabove, it is assumed that the plane wave light beam 14 consists only of a plane wave light beam whose wavefront is perpendicular to the optical axis 13, and the plane acoustic wave 9 consists only of a plane acoustic wave which is perpendicular to the acoustic axis 7. However, as previously described with reference to FIG. 2, the object 4 is not a point on the acoustic axis 7 but has a finite size, and therefore, the plane acoustic wave 9 converted by the acoustic lens system 6 includes a large number of plane acoustic waves which are not perpendicular to the acoustic axis 7. In the acousto-optic imaging device of the present embodiment, the plane wave light beam 14 is formed by superposition of a plurality of monochromatic light rays traveling in different directions, so that even a plane acoustic wave 9 traveling in a different direction can produce Bragg diffracted light.

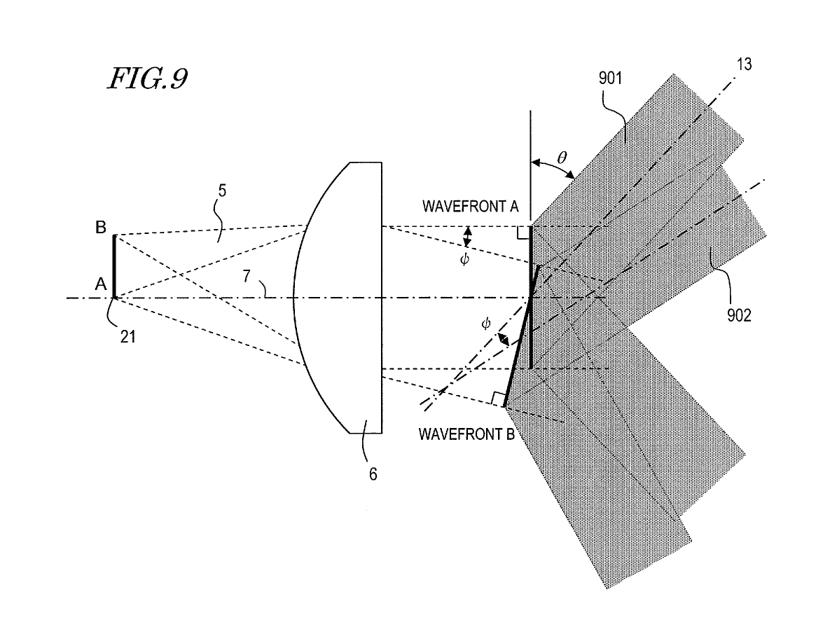

FIG. 9 illustrates conversion of the scattered waves 5 produced at two points A, B on the object 4, which are on the focal plane 21 of the acoustic lens system 6, into the plane acoustic waves 9, so that Bragg diffracted light is produced. Point A is present at the intersection of the acoustic axis 7 and the focal plane 21, while the point B is not present on the acoustic axis 7. As previously described with reference to FIG. 2, the wavefront A of the plane acoustic wave 9 that is derived from the scattered wave 5 produced at the point A is a flat plane which is perpendicular to the acoustic axis 7. However, the wavefront B of the plane acoustic wave that is derived from the scattered wave 5 produced at the point B that is out of the acoustic axis 7 is not a flat plane which is perpendicular to the acoustic axis 7, but the wavefront B forms angle ψ with respect to the acoustic axis 7 as shown in the drawing. Here, the angle ψ is defined in the same way as in FIG. 2.

Among a large number of plane wave light beams produced by the light source 19, a plane wave light beam 901 which is parallel to the optical axis 13 is now considered. The angle between the acoustic axis 7 and the optical axis 13 is adjusted such that the plane wave light beam 901 is incident on the wavefront A at angle θ which satisfies the Bragg diffraction condition. Therefore, diffracted light is produced at the wavefront A. On the other hand, the incidence angle of the plane wave light beam 901 on the wavefront B is θ−ψ, which does not satisfy the Bragg diffraction condition, so that diffracted light is not produced. Thus, only with the plane wave light beam 901, diffracted light corresponding to the scattered wave 9 from the point B is not produced, so that the real image 18 lacks an optical image corresponding to the point B.

To produce diffracted light at the wavefront B, the wavefront B is irradiated with a plane wave light beam 902 which is inclined in a clockwise direction by the angle ψ with respect to the optical axis 13 as shown in FIG. 9. Since the plane wave light beam 902 is incident on the wavefront B at the angle θ, diffracted light corresponding to the scattered wave 9 from the point B is produced. In this case, an optical image corresponding to the point B is included in the real image 18.

To make optical images corresponding to the point A and the point B appear as the real image 18 as described above, it is preferred to use both the plane wave light beam 901 and the plane wave light beam 902. Likewise, to make points on the object 4 other than the point A and the point B precisely appear in the real image 18, it is preferred that Bragg diffracted light is produced by plane acoustic waves 9 which are derived from scattered waves 5 produced at those points and whose wavefronts are not perpendicular to the acoustic axis 7. It is preferred that plane wave light beams provided to this end are incident on the acousto-optic medium section 8 at various angles other than 0 with respect to the wavefront A that is not perpendicular to the acoustic axis 7. According to the present embodiment, the light source 19 emits a light beam which is formed by superposition of a plurality of monochromatic light rays traveling in different directions, and therefore, the above condition is suitably satisfied. Thus, an image of the object 4 that is present at the focal plane 21 can be imaged.

On the focal plane 21, the actual object 4 is formed by a countless number of points. Therefore, to image the object 4 with high resolution, it is necessary to provide a countless number of plane wave light beams. Only with a finite number of plane wave light beams which have discrete incidence angles as in the present embodiment, one might think that the real image 18 is an optical image which is formed by an equal number of discrete points to the number of plane light beams. However, the plane acoustic wave 9 is a pulsed acoustic wave which is formed by a finite number of wavefronts. Therefore, the number of grating planes of the diffraction grating generated in the acousto-optic medium section 8 is also finite. As described above, diffracted light which is produced by the diffraction grating that has a finite number of grating planes includes Raman-Nath diffracted light in addition to Bragg diffracted light. The diffraction condition for Raman-Nath diffraction does not depend on the incidence angle. Therefore, for example, even when the irradiation is carried out only with the plane wave light beam 901, in actuality, not only an optical image of the point A but also optical images of its vicinal points are produced as the real image 18. Thus, in actuality, the produced real image 18 is not an aggregation of discrete points but a continuous optical image which is similar to the object 4.

Since the intensity of the Raman-Nath diffracted light is weak, when the Raman-Nath diffraction is dominant in the diffracted light 201, the resultant real image 18 of the object 4 is unsharp. Therefore, the proportion of the intensity of the Bragg diffracted light in the diffracted light 201 may be not less than ½. To this end, it is desired that the plane acoustic wave 9 is a pulsed acoustic wave that has a number of wavefronts whose number is equal to or greater than the number of wavefronts expressed by formula (4), Nₘᵢₙ. Note that, in formula (4), nₐₒ is the refractive index of the acousto-optic medium 8, λa is the wavelength of the acoustic wave in the acousto-optic medium 8, and λo is the wavelength of the light emitted from the monochromatic light source in the acousto-optic medium 8,

$$\begin{matrix}[ Expression 4 ] & \\ {N}_{min} = 10 \times \frac{{n}_{ao} {λ}_{a}}{2 π {λ}_{o}} & ( 4 )\end{matrix}$$

For example, when the acousto-optic medium 8 used is a nanofoam with a sound velocity of 50 m/s and an ultrasonic wave of 5 MHz, Nₘᵢₙ=13 because the refractive index of the nanofoam is approximately 1. Therefore, in this case, when a pulsed ultrasonic wave whose wavefront number is not less than 13 is used, the Bragg diffracted light is a major diffracted light component.

As previously described with reference to FIG. 7 and FIG. 8, the light beam magnification rate of the anamorphic prism 301 depends on the incidence angle of a light ray on the anamorphic prism 301 (which corresponds to angle θ1 in FIG. 8). Therefore, diffracted light rays which are produced according to a plurality of monochromatic light rays superposed in the plane wave light beam are incident on the anamorphic prism 301 at different incidence angles, so that the light beam magnification rate varies among the monochromatic light rays. As a result, the real image 18 has a distortion even though the distortion of an image of an object is corrected by the anamorphic prism 301. To remove this distortion, the present embodiment includes the image processing section 20 as shown in FIG. 1. The image processing section 20 carries out image processing on image data obtained by the image receiving section 17 to correct the remaining distortion in the real image 18 such that an image which is similar to the object 4 is obtained. For example, preliminarily, a real image 18 of a graph paper which is used as the object 4 is obtained, and the image processing is carried out such that the obtained real image is corrected to have a regular grid over the entire surface.

However, when the F-number of the acoustic lens system 6 is large (i.e., when the lens aperture is small, and the focal length is long), or when the imaging region on the object 4 is small, the difference in incidence angle on the anamorphic prism 301 between diffracted light rays of different angles which are included in the diffracted light 201 is small, so that the light beam magnification rate can be regarded as generally constant. Thus, in such a case, the image processing section 20 does not need to correct the distortion of the real image 18.

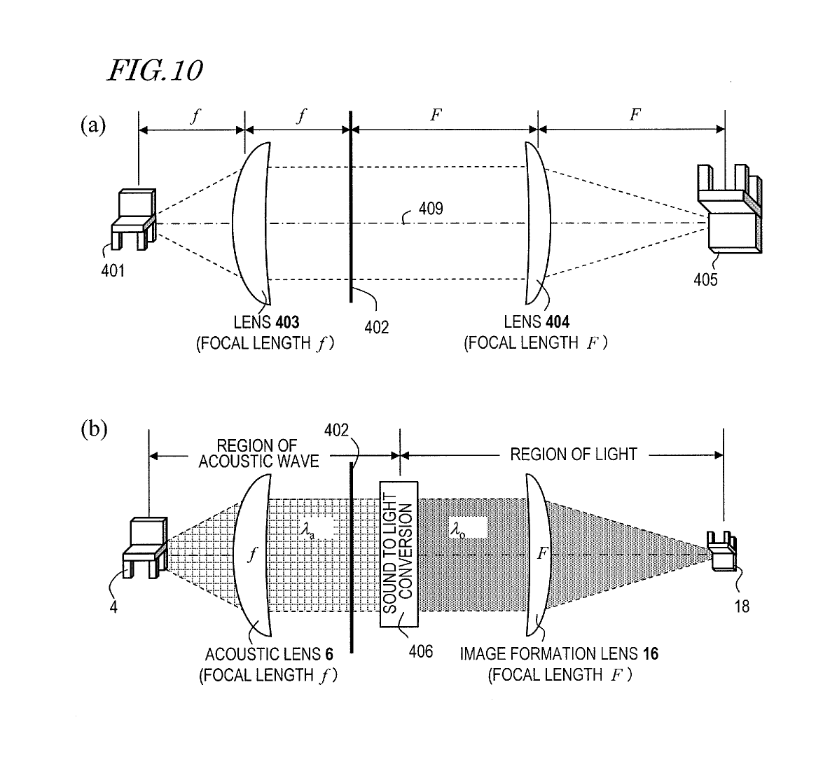

Next, the relationship in size between the object 4 and the real image 18 in the acousto-optic imaging device of the present embodiment is described. The acousto-optic imaging device of the present embodiment can be regarded as a variation optical system of a double diffraction optical system that is formed by two optical lenses which have focal lengths f and F. FIG. 10(a) shows a schematic diagram for illustrating the operation of the double diffraction optical system in the field of optics.

In the double diffraction optical system shown in FIG. 10(a), a lens 403 and a lens 404 have focal lengths f and F, respectively. These lenses are provided on an optical axis 409 with a separation of f+F therebetween. The optical axes of these lenses are identical with the optical axis 409. In general, a convex lens that has focal length fl has two focal points on the optical axis, which are on the opposite sides of the lens and which are distant from the lens by fl. According to the Fourier optics, an object which is placed at one of the focal points of the convex lens and an optical image which is at the other focal point are mutually in a relationship of the Fourier transform. Therefore, a Fourier transformed image of an object 401 which is produced by the lens 403 is formed on a Fourier transform plane 402 which is another focal plane (i.e., a plane which includes the focal point and which is perpendicular to the optical axis). Since the Fourier transform plane 402 is also a focal plane of the lens 404, a Fourier transformed image of the Fourier transformed image of the object 401 which is formed on the Fourier transform plane 402 is formed on another focal plane of the lens 404. That is, the optical image formed on another focal plane of the lens 404 is equivalent to a twice Fourier transformed image of the object 401. Since carrying out the Fourier transform twice means similarity mapping (mapping which is achieved by multiplying the size of a figure by a constant and transforming only the orientation of the figure), a real image 405 which is a twice Fourier transformed image of the object 401 is a figure which is similar to the object 401. Note that the real image 405 appears as a reversal image of the object 401 on a focal plane of the lens 404, and the size of the real image 405 is F/f times the size of the object 401 because the lens 403 and the lens 404 have different focal lengths. As described herein, in the double diffraction optical system of FIG. 10(a), an optical image which is similar to the object 401 appears as the real image 405. When an imaging device, such as CCD or the like, is provided on a focal plane of the lens 404 on which a real image is to be formed, imaging of the object 401 can be performed.

The acousto-optic imaging device of the present embodiment can be regarded as a double diffraction optical system in which one of the two optical systems is replaced by an acoustic system. As previously described with reference to FIG. 6 and FIG. 7, production of the diffracted light 201 in the acousto-optic imaging device of the present embodiment, and the image distortion correcting section 15, can be regarded as a wavelength converting section 406 for converting (transferring) the amplitude distribution (acoustic pressure) across the wavefront of the plane acoustic wave 9 that is a plane wave at wavelength λa into the amplitude distribution (light) of the distortion-corrected diffracted light 302 that is a plane wave at wavelength λo. Therefore, the acousto-optic imaging device of the present embodiment is an acousto-optic-combined optical system in which an optical system and an acoustic system are combined. The lens 403 and the lens 404 shown in FIG. 10(a) are replaced by the acoustic lens system 6 and the image formation lens system 16 as shown in FIG. 10(b), and the wavelength converting section 406 provided between these two lens systems for converting the wavelength from λa to λo converts an acoustic wave to a light wave. In this way, the acousto-optic imaging device of the present embodiment carries out the same operation as the double diffraction optical system shown in FIG. 10(a). Thus, according to the Fourier optics, also in the acousto-optic-combined optical system of FIG. 10(b), an optical image which is similar to an object 407 is obtained as an inverted real image on the focal plane of the image formation lens system 16 as in FIG. 10(a).

Note that, however, the wavelength changes from λa to λo at the wavelength converting section 406. In the acousto-optic-combined optical system of FIG. 10(b), the size of the real image 18 is (F×λo)/(f×λa) times the size of the object 4. When λo/λa is extremely small, i.e., when the wavelength of the acoustic wave in the acousto-optic medium section 8 is very long as compared with the wavelength of the plane wave light beam 14, F/f may be increased to increase (F×λo)/(f×λa) such that the real image 18 is not extremely small, whereby decrease in resolution of an optical image obtained in the image receiving section 17 can be prevented.

As described above, according to the acousto-optic imaging device of the present embodiment, a light beam which is formed by a plurality of superposed monochromatic light rays traveling in different directions is transmitted through an acousto-optic medium section through which a scattered light from an object is propagating, whereby diffracted light is produced according to the refractive index distribution caused by a plane acoustic wave converted from the scattered wave. In conversion of the scattered wave by an acoustic lens system into the plane acoustic wave propagating through the acousto-optic medium, scattered wave from an object that is present at a position which is distant from the acoustic axis of the acoustic lens system travels in a direction which is not parallel to the acoustic axis. However, since the traveling directions of the plurality of superposed monochromatic light rays of the light beam are different, Bragg diffracted light is also produced even according to the refractive index distribution of the acousto-optic medium which is caused by the scattered wave from the position that is distant from the acoustic axis. As a result, even at a position which is out of the acoustic axis of the acoustic lens system, the object can be imaged with low aberration and high resolution. That is, a high resolution image with small coma aberration can be obtained.

According to the present embodiment, the acousto-optic imaging device forms a double diffraction optical system which is realized by an acoustic system and an optical system, and therefore, the distance between the acoustic system and the optical system can be decreased, and accordingly, the size of the acousto-optic imaging device can be decreased. Further, it is not necessary to fill an object with a solution, such as water or the like, so that the object can be imaged from an arbitrary direction.

In the present embodiment, the focal length of the acoustic lens system 6 of the acousto-optic imaging device 101 is fixed although, as described above, the acoustic lens system 6 may include a focusing mechanism (focal point adjustment mechanism), such as those provided for common photographic lenses. When the focal point of the acoustic lens system 6 is fixed, a sharp real image 18 can be obtained only from an object 4 which is present in a region in the vicinity of the focal plane of the acoustic lens system 6 (precisely, an object 4 which is present within the depth of field which is determined based on the optical characteristics of the acoustic lens system 6 and the image size of the image receiving section 17). In view of such, providing a mechanism which is capable of adjusting the focal point of the acoustic lens system 6 in the acoustic lens system 6 enables imaging of the object 4 in the optical axis direction. In this way, providing a focusing mechanism enables imaging of a three-dimensional region.

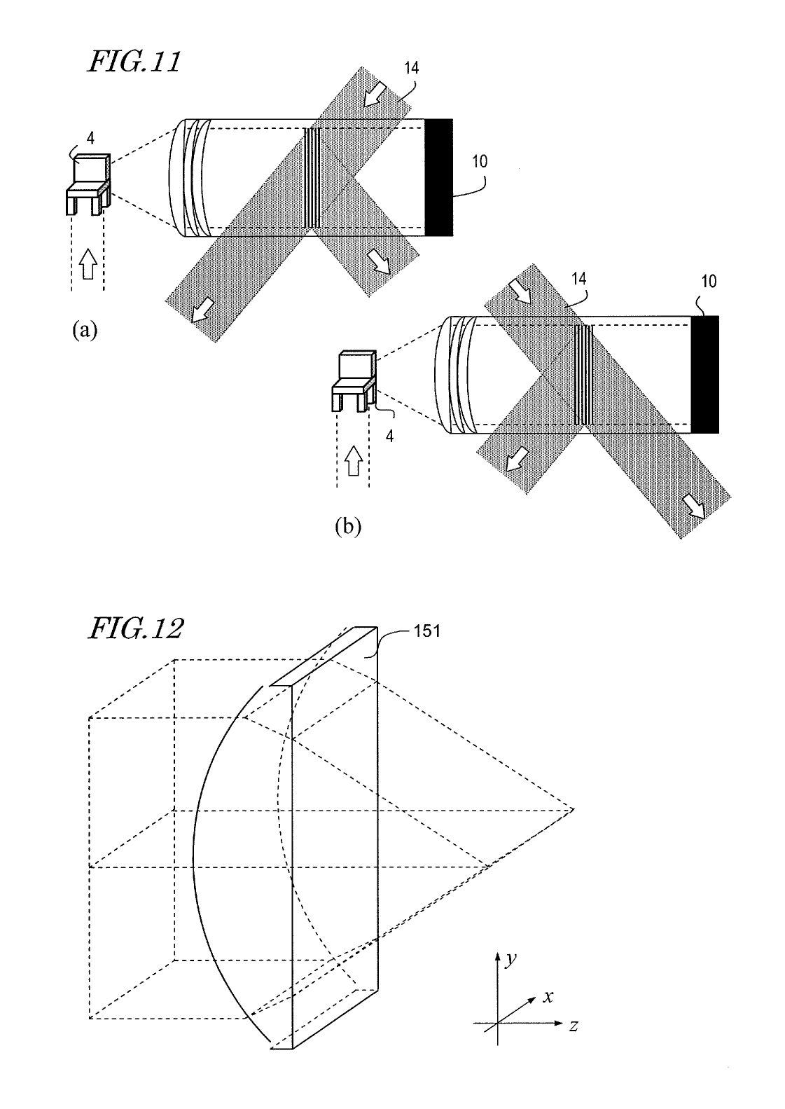

In the present embodiment, irradiation is carried out with the plane wave light beam 14 being inclined from the acoustic wave absorbing section 10 in the direction of the object 4 as shown in FIG. 11(a). However, irradiation may be carried out with the plane wave light beam 14 being inclined from the object 4 side in the direction of the acoustic wave absorbing section 10 as shown in FIG. 11(b). When irradiation is carried out with the plane wave light beam 14 as shown in FIG. 11(b), a real image obtained is in a mirror image relationship to the real image produced in the configuration of FIG. 11(a) where the drawing sheet of FIG. 11 is a mirror image symmetry plane. Therefore, to obtain a real image 18 of the object 4 with a correct orientation, it is preferred to reflect a captured image once using a plane mirror such that the captured image is optically reversed so as to obtain a mirror image or to optically reverse a captured image using the image processing section 20 so as to obtain a mirror image.

In the present embodiment, the anamorphic prism 301 is used as the image distortion correcting section 15, although a different optical system which has the same optical functions may be used. For example, the image distortion correcting section 15 may be formed using two condensing-type cylindrical lenses. As shown in FIG. 12, a cylindrical lens 151 is an optical element which functions as a condensing lens in a plane that is parallel to the y-z plane of the coordinate system shown in the drawing but does not have a light-condensing function in a plane that is parallel to the x-z plane. An optical system shown in FIG. 13, which is formed by combination of two cylindrical lenses 161, 162 whose planes of light-condensing function are perpendicular to each other, functions as an optical system which has both the function of the image distortion correcting section 15 and the function of the image formation lens system 16. As shown in FIG. 13, the cylindrical lens 161 condenses light in the x-y plane onto a line which is parallel to the y-axis, and the cylindrical lens 162 condenses light in the y-z plane onto a line which is parallel to the x-axis. The cylindrical lens 161 has a greater focal length than the cylindrical lens 162, and therefore, it functions as an optical system which realizes image formation at different ratios in the y-z plane and the x-z plane. When this optical system is provided in the same orientation in the coordinate system shown in FIG. 7(a), it suitably functions as the image distortion correcting section 15 of the acousto-optic imaging device 101. Specifically, the focal lengths of the both lenses are selected to correct the oblateness sin θ of the light beam shown in FIG. 3 such that the aspect ratio of an image between the y-axis direction and the x-axis direction is 1/sin θ. More specifically, the focal lengths of the lenses are selected such that the focal length of the cylindrical lens 162 is sin θ times the focal length of the cylindrical lens 161. In this case, the focal length of the cylindrical lens 161 is determined based on the scaling factor between the object 4 and the real image 18.

In the acousto-optic imaging device 101 in which the optical system of FIG. 13 is used instead of the image distortion correcting section 15 and the image formation lens system 16, distortion correction by the image processing section 20 is not necessary so long as the distortions of the cylindrical lens 161 and the cylindrical lens 162 are sufficiently corrected.

### Second Embodiment

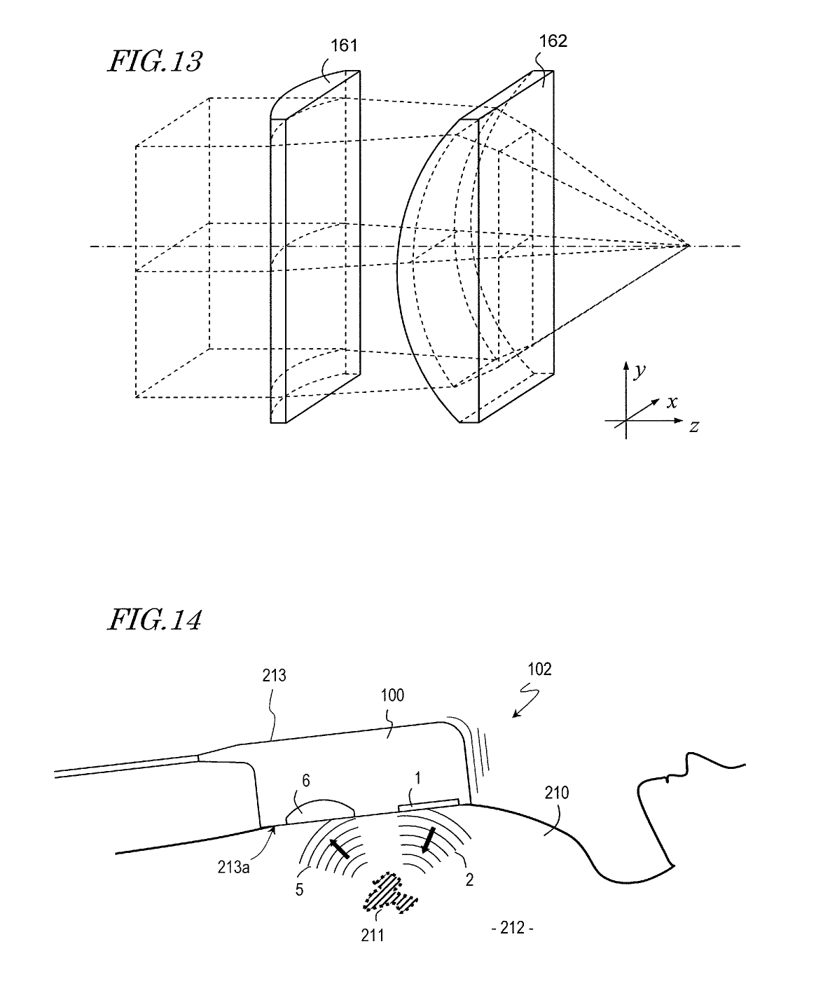

Hereinafter, the second embodiment of the acousto-optic imaging device of the present invention is described. FIG. 14 schematically shows an acousto-optic imaging device 102 of the present embodiment. The acousto-optic imaging device 102 uses an ultrasonic wave as the acoustic wave 2 to noninvasively image organs inside a human or animal body. As shown in FIG. 14, the acousto-optic imaging device 102 has the same configuration as that of the acousto-optic imaging device 101 of the first embodiment. In the acousto-optic imaging device 102, all the components of the acousto-optic imaging device 101 shown in FIG. 1, or all the components except for the light source 19, are stored in a probe 213 as in common ultrasonic probes.

As shown in FIG. 14, the acoustic wave source 1 and the acoustic lens system 6 are provided at a probing surface 213a of the probe 213. As shown in FIG. 14, in an imaging process, the probing surface 213a of the probe 213 is brought into contact with a body surface of a subject 210, and the acoustic wave 2 that is produced by the acoustic wave source 1 outside the body is supplied into the inside of the body. In this process, to reduce the reflection loss at the body surface, matching gel or cream or an acoustic impedance matching layer may be provided between the probing surface 213a and the body surface such that matching of the acoustic impedance is achieved.

The acoustic wave 2 propagates through a body tissue 212 and is reflected and scattered by an organ 211, resulting in a scattered wave 5. The scattered wave 5 reaches the acoustic lens system 6 and is converted by the acoustic lens system 6 into a plane wave, so that an image of the organ 211 can be obtained as previously described in the first embodiment. Imaging of the organ 211 that is present in a plane which is perpendicular to the acoustic axis 7 (not shown) of the acousto-optic imaging device 102 but lying outside the imaging region can be realized by moving the acousto-optic imaging device 101 across the body surface as is the case with conventional ultrasonic probes. Imaging of organs at different depths inside the body can be realized by adjusting the position of the focal point using the focal point adjustment mechanism of the acoustic lens system 6 as previously described in the first embodiment.

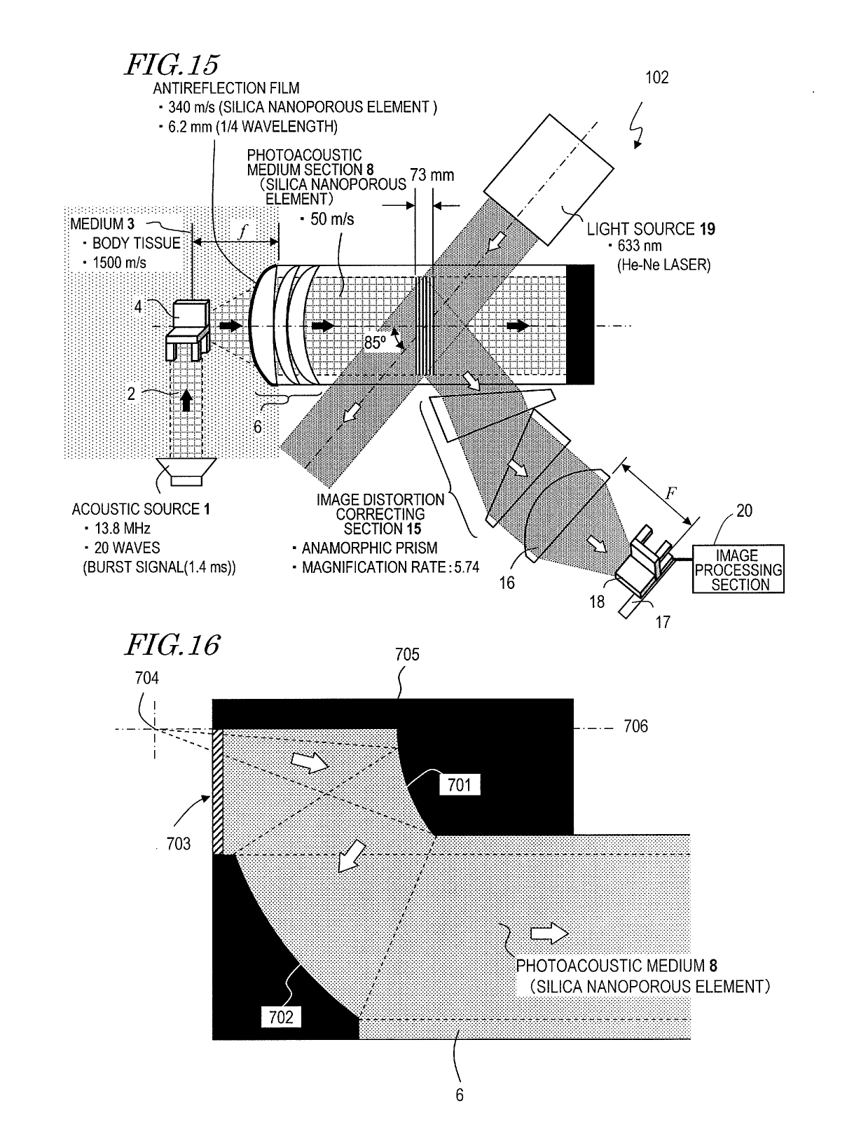

A specific configuration example which can realize the acousto-optic imaging device 102 is described with reference to FIG. 15. The acoustic wave source 1 emits a burst signal which is formed by 20 sine waves at the frequency of 13.8 MHz, for example. The signal duration of this burst signal is 1.4 μsec. The sound velocity in the body tissue 212 is about 1500 m/s, and accordingly, the wavelength of an ultrasonic sine wave in the body tissue 212 is about 110 μm, and the physical signal length of the burst signal measured parallel to the traveling direction of the ultrasonic wave is about 2.2 mm. Thus, in this case, the organ 211 which is vibrating at the frequency of several hundreds of kHz at the maximum can be imaged at the spatial resolution of several hundreds of μm.

The acousto-optic medium section 8 used may be a silica nanoporous element with the sound velocity of 50 m/s. The silica nanoporous element has a low sound velocity and a short propagation wavelength for ultrasonic waves and therefore provides a large diffraction angle. The silica nanoporous element has sufficient transparency for He—Ne laser light at the wavelength of 633 nm. Another example is Fluorinert, which also has sufficient transparency for He—Ne laser light at the wavelength of 633 nm. Fluorinert has a sound velocity of about 500 m/s and is therefore suitably used as the acousto-optic medium section 8.

When the light source 19 used is a He—Ne laser at the wavelength of 633 nm, the diffraction angle of the 1st order diffracted light is 5′. In this case, the beam magnification rate which needs to be achieved by the image distortion correcting section 15 is about 5.74. This value is correctable by a commercially available anamorphic prism.

The acoustic pressure of the acoustic wave which can be supplied for irradiation of the inside of the body has the upper limit for safety reasons. Therefore, it is desired that the light intensity of produced diffracted light is weak and the image receiving section 17 has high sensitivity. From the viewpoint of the image quality and the amount of light, to capture a real image 18 at the moment when the plane acoustic wave 9 traverses the plane wave light beam 14, and to observe the motion of the object 4 by continuous shooting, the image receiving section 17 used may be an imaging device which is capable of high speed imaging. For example, the image receiving section 17 used may be a high-speed CCD Image Sensor (Charge Coupled Device Image Sensor). When imaging is difficult because of insufficient brightness of the real image 18, an image intensifying tube may be provided immediately before the above-described image sensor to increase the brightness of the real image 18, or a light source 11 of greater power may be used.

As previously described in the description of the acoustic lens system 6, an acoustic wave is reflected at the interface between acoustic media which have different acoustic impedances, causing a deterioration in brightness or image quality of the real image 18. As the difference in acoustic impedance at the interface increases, the reflection increases. In view of this, an antireflection film may be provided at the interface between the acoustic lens system 6 and the medium 3 as shown in FIG. 15. For example, when a lens of the acoustic lens system 6 which is in contact with the medium 3 (body tissue 212) is formed by a silica nanoporous element with the sound velocity of 50 m/s and the density of 0.11 g/cm³, a 6.2 μm thick ¼-wavelength antireflection film which is formed by a silica nanoporous element with the sound velocity of 340 m/s and the density of 0.2/cm³ may be formed on the surface of the lens.

To obtain on the image receiving section 17 a real image 18 whose size is ⅕ of the object 4, F/f=1.14. Since the size of the real image 18 is (F×λo)/(f×λa) times the size of the object 4 as previously described in the first embodiment, the relational expression of (F×λo)/(f×λa)=⅕ holds true. Therefore, F/f=λa/λo/5 holds true. Assigning 633 nm to the wavelength λo of the light (λo=633 nm) and 3.6 μm to the wavelength λa of the 13.8 MHz ultrasonic wave in the acousto-optic medium section 8 which is formed by the silica nanoporous element with the sound velocity of 50 m/s (λa=3.6 μm) results in F/f=1.14. Therefore, when the acoustic lens system 6 which has the focal length of 50 mm is used, the image formation lens system 16 which has the focal length of 57 mm is used (F=1.14×f=1.14×50 mm).

As previously described with reference to FIG. 10, when the scaling factor of the real image 18 relative to the object 4, (F×λo)/(f×λa), is increased, the focal length of the image formation lens system 16 increases, and the size of the acousto-optic imaging device 102 also increases. In this case, this problem can be solved by using a return reflection optical system, which is typified by a Cassegrain optical system, for example, as the image formation lens system 16. Employing the return reflection optical system enables an arrangement such that the distance between the image formation lens system 16 and the real image 18 is smaller than the actual focal length F. Therefore, the size of the acousto-optic imaging device 102 can be reduced.

Also, the size of the acousto-optic imaging device 102 can be reduced by making the distance between the acoustic lens system 6 and the image formation lens system 16 smaller than f+F. As previously described with reference to FIG. 10, the acousto-optic-combined optical system of the acousto-optic imaging device 101 can be regarded as a double diffraction optical system in the field of optics. According to the basic configuration of the double diffraction optical system, the acoustic lens system 6 and the image formation lens system 16 are arranged such that they are distant from each other by the sum of the focal lengths of the lenses, f+F. However, even if the distance between the acoustic lens system 6 and the image formation lens system 16 is set to a value which is different from f+F, it would not affect optical image formation of the real image 18. That is, so long as the optical image of the real image 18 is obtained in the form of a light intensity distribution (or so long as the phase distribution data of the real image 18 is not observed), the distance between the acoustic lens system 6 and the image formation lens system 16 may be shorter than f+F. Thus, the size of the acousto-optic imaging device 102 can be further reduced.

In the present embodiment, the example of the acousto-optic imaging device 102 which is configured to extracorporeally image organs inside a human or animal body has been described. The present invention may be carried out in the form of an acousto-optic imaging device which is configured to intracorporeally image organs or vascular walls through a catheter, endoscope, laparoscope, or the like.

### Third Embodiment

The third embodiment of the acousto-optic imaging device of the present invention is described. The acousto-optic imaging device of the third embodiment is the same as the acousto-optic imaging device 101 of the first embodiment except that the acoustic lens system 6 has a different configuration. Thus, only the configuration of the acoustic lens system 6 is described herein. FIG. 16 shows the configuration of the acoustic lens system 6 in the present embodiment.

In the first embodiment, all the components of the acoustic lens system 6 are formed by silica nanoporous elements. The silica nanoporous element is advantageous in that the sound velocity of an acoustic wave, such as an ultrasonic wave, in the silica nanoporous element can be changed within a wide range by adjusting the manufacturing conditions. The ratio of the sound velocity in the silica nanoporous element to the sound velocity in the medium 3 corresponds to the refractive index in the optical system. That is, the silica nanoporous element is a flexible acoustic medium with which various refractive indices (for ultrasonic waves) can be readily achieved. Therefore, when the silica nanoporous element is employed as the components of the acoustic lens system 6, the design flexibility of the acoustic lens system 6 improves thanks to wide selectivity of the refractive index for the acoustic wave. The respective aberrations can be suitably corrected as in the case of optical lenses in a common multi-group configuration, and the acoustic lens system 6 with a wide image circle can be structured. Note that the image circle means a region on a focal plane in which excellent image-forming characteristics can be obtained.

The acoustic lens system 6 of the first embodiment has such an advantage but has a problem as described below, which occurs because silica nanoporous elements are joined together. For example, even in the case where the acoustic lens system 6 has a simple lens configuration, joining of silica nanoporous elements occurs when a silica nanoporous element is employed for the acousto-optic medium section 8 as in the specific example shown in FIG. 15. In the case where the acoustic lens system 6 has a multi-group lens configuration and a compound lens, such as an achromat lens in the field of optics, is used, joining of silica nanoporous elements occurs.

The silica nanoporous element and air have greatly different acoustic impedances. Therefore, to prevent production of a reflection wave at the joint surface, preventing formation of an air layer at the joint surface of the silica nanoporous elements is significant. However, in consideration of the process of fabricating the silica nanoporous elements, joining the silica nanoporous elements without forming an air layer therebetween is very difficult. Thus, in the acoustic lens system 6 of the first embodiment, it is difficult to prevent production of a reflection wave at the joint surface.

To solve the above problem, the acoustic lens system 6 of the present embodiment is formed by a reflective acoustic system. FIG. 16 is a cross-sectional view of the acoustic lens system 6 in a plane which includes an acoustic axis 706. The acoustic lens system 6 includes an acoustic waveguide 704, and a primary mirror 702 and a secondary mirror 701 which are reflection surfaces provided inside the acoustic waveguide 704. Further, an acousto-optic medium section is provided inside the acoustic waveguide 704. The acoustic waveguide 704 has a mirror image symmetrical configuration where the drawing sheet of FIG. 16 is the mirror image symmetry plane. The cross-sectional structure shown in FIG. 16 is rotated by 180° about the acoustic axis 706. The resultant rotated structure is cut by two planes which are parallel to the mirror image symmetry plane and which are on the opposite sides of the mirror image symmetry plane, the mirror image symmetry plane being a plane including the acoustic axis 706. As a result, a three-dimensional shape of the acoustic waveguide 704 is obtained. Such an acoustic waveguide 705 is realized by, for example, preparing an acoustic waveguide 705 which is formed of a metal by machining or the like so as to have reflection surfaces, and filling the prepared acoustic waveguide with an isotropic silica nanoporous element so as to integrally form the acousto-optic medium section 8 and the acoustic lens system 6. Such a process enables formation of the acoustic lens system 6 with excellent aberration correction, while eliminating all the joining portions of the silica nanoporous elements.

An example of a reflective optical system which is preferred in the present embodiment is a Cassegrain optical system which is formed by the primary mirror 702 which is a concave mirror and the secondary mirror 701 which is a convex mirror as shown in FIG. 16. Further, employing a Ritchey-Chretien optical system for the surface shapes of the primary mirror 702 and the secondary mirror 701, a remaining aberration of the Cassegrain optical system which can occur with a decreased focal length can be desirably corrected, so that a large image circle can be achieved. The Ritchey-Chretien optical system has an image plane curvature remaining at the focal point. This image plane curvature can be corrected by providing curving processing to the interface of the silica nanoporous element on the focal point side (a surface provided with an antireflection film 703) so as to function as a correcting lens. Other examples of the reflective optical system include a Gregory optical system in which a concave mirror is used for the secondary mirror 701, and other catadioptric optical systems, such as a Schmidt-Cassegrain optical system.

By employing a reflective optical system as the acoustic lens system 6, the acoustic lens system 6 which includes only a single silica nanoporous element so that the aberration is desirably corrected can be formed without joining a plurality of types of silica nanoporous elements which are difficult for manufacture. Since no reflection wave is produced in the vicinity of the acoustic lens system 6, the real image 18 with high brightness and high image quality can be obtained. Thus, according to the present embodiment, an acousto-optic imaging device can be realized which is capable of obtaining an image with higher brightness and higher image quality.

### Fourth Embodiment

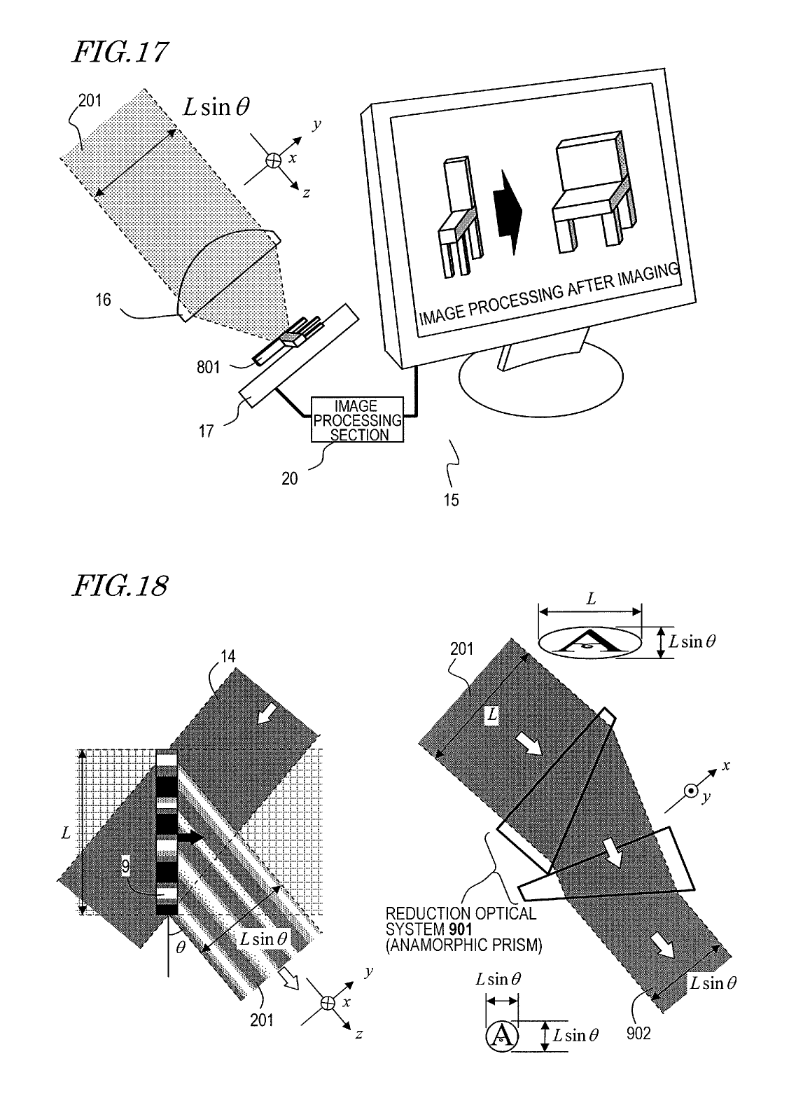

The fourth embodiment of the acousto-optic imaging device of the present invention is described. The acousto-optic imaging device of the fourth embodiment is the same as the acousto-optic imaging device 101 of the first embodiment except that the image distortion correcting section 15 has a different configuration. Thus, only the configuration of the image distortion correcting section 15 is described herein. FIG. 17 schematically shows the configuration of the image distortion correcting section 15 in the present embodiment.

In the first embodiment, the image distortion correcting section 15 includes an optical system in which an anamorphic prism and cylindrical lenses are used. On the other hand, the image distortion correcting section 15 of the present embodiment carries out predetermined processing on a signal of a real image 801 obtained by the image receiving section 17 and carries out image processing to correct the real image 801.

As shown in FIG. 17, in the present embodiment, an anamorphic prism or cylindrical lens are not used, and diffracted light 201 which has distortion is converted into an image by the image formation lens system 16. In this case, the real image 801 is distorted in the y-axis direction, and the real image 801 in this state is received by the image receiving section 17. The image processing section 20 receives an electric signal which represents the real image 801 from the image receiving section 17 and carries out image processing to remove the image distortion from the real image 801. For example, the image processing is carried out to magnify the real image 801 in the y-direction by a factor of 1/sin θ in the coordinate system shown in FIG. 17, whereby an image which is similar to the object 4 is generated.

When the image distortion correcting section 15 of the present embodiment is used, the number of optical elements used in the configuration of the acousto-optic imaging device can be reduced. Thus, a small-sized acoustic imaging device can be provided at a low cost.

When the diffraction angle θ is small, an image of the object 4 which is greatly expanded in the y-axis direction of the coordinate system shown in FIG. 7 is formed on the imaging plane of the image receiving section 17. Therefore, the image which has undergone the image processing has different image resolutions in the x-axis direction and the y-axis direction. In this case, when an acousto-optic imaging device includes both the optical image distortion correcting section 15 shown in FIG. 8 and the image distortion correcting section 15 of the present embodiment which is realized by the image processing, the image resolution in the x-direction and the image resolution in the y-direction can be generally equal.

When the anamorphic prism 301 is used as the optical image distortion correcting section 15 shown in FIG. 7 and the image distortion correcting section 15 of the present embodiment which is realized by the image processing is further used, an image plane distortion is caused because the incidence angles of a large number of diffracted light rays 201 onto the anamorphic prism 301 are different. Therefore, correction of that aberration can be carried out by the image processing of the present embodiment.

### Fifth Embodiment

The fifth embodiment of the acousto-optic imaging device of the present invention is described. The acousto-optic imaging device of the fifth embodiment is the same as the acousto-optic imaging device 101 of the first embodiment except that the image distortion correcting section 15 has a different configuration. Thus, only the configuration of the image distortion correcting section 15 is described herein. FIG. 18 schematically shows the configuration of the image distortion correcting section 15 in the present embodiment.

Where the diffraction angle of diffracted light is θ (the definition of θ is the same as that described above), the image distortion correcting section 15 of the present embodiment includes a reduction optical system 901 for reducing the light beam width of the diffracted light 201 by a factor of sin θ in the x-axis direction of the coordinate system shown in FIG. 18. Assuming that the cross-sectional shape of the sound beam of the plane acoustic wave 9 is a circular shape with diameter L, the cross-sectional shape of the light beam of the diffracted light 201 is an elliptical shape with L in the x-axis direction and L×sin θ in the y-axis direction. The reduction optical system 901 reduces the diffracted light 201 in the x-axis direction by a factor of sin θ, and therefore, the cross-sectional shape of the light beam of distortion-corrected diffracted light 902 is a circular shape with diameter L×sin θ. Although in the first and second embodiments the image distortion correcting section 15 corrects the diffracted light 201 into a light beam with diameter L, the image distortion correcting section 15 of the present embodiment corrects the diffracted light 201 into a light beam with diameter L×sin θ.

In the present embodiment, as in the first embodiment, the focal length of the acoustic lens system 6 is f, the focal length of the image formation lens system 16 is F, the wavelength of the plane acoustic wave 9 that is an ultrasonic wave is λa, the wavelength of the plane wave light beam 14 that is monochromatic light is λo, and the diffraction angle is θ. Here, the cross-sectional shape of the light beam of the distortion-corrected diffracted light 902 is a circular shape, and therefore, the real image 18 is similar to the object 4. According to the Fourier optics, its scaling factor is (λa×f)/(λo×F)×sin θ. However, since there is the relationship of Formula (1), when the diffracted light 201 is +1st order diffracted light, the scaling factor is ½×(f/F).

As described above, thanks to the reduction optical system 901, the scaling factor does not depend on the wavelengths of the ultrasonic wave and the monochromatic light. Therefore, for example, by selecting the focal length ratio between the acoustic lens system 6 and the image formation lens system 16 so as to be f/F=2, a real image 18 which has the same size as the object 4 is obtained, and an image of the object 4 can be obtained with high resolution. Further, since F decreases as f decreases, size reduction of the acousto-optic imaging device can also be realized. Further, the light beam of the distortion-corrected diffracted light 902 becomes thinner, and therefore, the aperture diameter of the image formation lens system 16 decreases, and the size of the entire apparatus is reduced, while high plane accuracy is not necessary in the image formation lens system 16.

In the first and second embodiments, the scaling factor of the real image 18 relative to the object 4 is (F×λo)/(f×λa). As previously described for the specific example shown in FIG. 15, in actuality, the ultrasonic wave wavelength λa is considerably longer than the monochromatic light wavelength λo. In view of such, to obtain a large real image 18, the image formation lens system 16 used has a very long focal length. Thus, the size of the acousto-optic imaging device 101 increases, or the image formation lens system 16 used has a particular optical system configuration. On the other hand, according to the present embodiment, the reduction optical system 901 is used as the image distortion correcting section 15. Thus, the real image 18 can be imaged with high resolution while the image formation lens system 16 used has a small aperture diameter and a short focal length, and at the same time, the size of the acousto-optic imaging device can be reduced.

According to the present embodiment, the reduction optical system 901 is realized by an anamorphic prism, although a different reduction optical system which has the same function may be used.

According to the present embodiment, when the cross-sectional shape of the sound beam of the plane acoustic wave 9 is a circular shape with diameter L, the distortion-corrected diffracted light 902 whose light beam cross-sectional shape is a circular shape with diameter L×sin θ is obtained. However, even when the diffracted light is corrected such that the cross-sectional shape of the light beam of the distortion-corrected diffracted light 902 is a circular shape with C×L (where C<1), the focal point of the image formation lens system 16 is shortened, and the resolution of imaging can be increased. For example, two image distortion correcting sections 15 may be provided such that a reduction optical system is used for the x-axis direction and a magnification optical system is used for the y-axis direction in the coordinate system shown in FIG. 18. Specifically, the beam reduction rate in the x-axis direction and the beam magnification rate in the y-direction are selected such that the cross-sectional shape of the light beam of the distortion-corrected diffracted light 902 is a circular shape with C×L (where C<1).

An acousto-optic imaging device may be realized which includes both the image distortion correcting section 15 of the present embodiment and the image distortion correcting section 15 of the fourth embodiment. The beam reduction rate of the reduction optical system 901 is set such that the cross-sectional shape of the light beam of the distortion-corrected diffracted light 902 is an elliptical shape with C×L (where C<1) in the x-axis direction and L×sin θ in the y-axis direction in the coordinate system shown in FIG. 17. With this feature, the resolutions of a captured image are generally equal irrespective of whether it is on the focal plane of the image formation lens system 16.

### Sixth Embodiment

The sixth embodiment of the acousto-optic imaging device of the present invention is described. The acousto-optic imaging device of the sixth embodiment is the same as the acousto-optic imaging device 101 of the first embodiment except that the image distortion correcting section 15 has a different configuration. Thus, only the configuration of the image distortion correcting section 15 is described herein. FIG. 19 schematically shows the configuration of the image distortion correcting section 15 in the present embodiment.

FIG. 19 shows a schematic configuration of the acousto-optic imaging device 106 of Embodiment 6. The acousto-optic imaging device 106 is different from the acousto-optic imaging device 101 of the first embodiment in that it further includes an angle adjustment section 1302 and an angle adjustment section 1303. Thus, descriptions of the other components are omitted. In the description of the present embodiment, elements which are the same as those of the first embodiment are designated by the same reference numerals.

As shown in FIG. 19, an optical system which is formed by the image distortion correcting section 15, the image formation lens system 16, and the image receiving section 17 is referred to as “diffracted-light image formation optical system 1304”. The optical axis 1301 is in a plane which includes the acoustic axis 7 and the optical axis 13. The optical axis 1301 is a line which is in a mirror image symmetry relationship to the optical axis 13 where the acoustic axis 7 is the symmetry axis.

The acousto-optic imaging device 106 of the present embodiment includes the angle adjustment section 1302 for adjusting the angle which is formed by the optical axis 13 of the light source 19 with respect to the acoustic axis 7 and the angle adjustment section 1303 for adjusting the angle which is formed by the optical axis 1301 of a diffracted-light image formation optical system 1305 with respect to the acoustic axis 7. The angle adjustment section 1302 and the angle adjustment section 1303 operate in connection with each other to adjust the angles such that the angle between the acoustic axis 7 and the optical axis 13 and the angle between the acoustic axis 7 and the optical axis 1301 are always equal to each other.

As previously described in the first embodiment, the diffraction angle of the diffracted light 201 with respect to the acoustic axis 7, 90°−θ, is determined based on the frequency of the sine waves that form the acoustic wave 2 and the wavelength of light emitted from the monochromatic light source 11. Therefore, even when the frequency of the acoustic wave 2 is varied, the acousto-optic imaging device 105 of the present embodiment adjusts the diffraction angle using the angle adjustment section 1302 and the angle adjustment section 1303 such that the object 4 can be imaged.

By adjusting the diffraction angle, the frequency of the acoustic wave 2 can be arbitrarily set in the acousto-optic imaging device 106. Thus, it is possible to, firstly, roughly image the object 4 with a low frequency acoustic wave and then image the object 4 using a high frequency acoustic wave with high resolution to the details. Accordingly, reduction of the imaging time and reduction of the amount of image data can be achieved.

An acousto-optic imaging device disclosed in the present application is capable of obtaining an ultrasonic wave image as an optical image, which is for various uses, and is therefore useful as a probe for an ultrasonographic device, etc. When the inside of an object, to which light cannot reach, is made of a material through which an ultrasonic wave can propagate, the elastic modulus distribution inside the object can be observed as an optical image. Therefore, the acousto-optic imaging device is also applicable to uses of nondestructive vibration measurement devices. Further, thanks to the capability of high-speed imaging, the acousto-optic imaging device disclosed in the present application is usable as a non-contact vibrometer for measuring motion in a non-contact fashion.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

What is claimed is:

1. An acousto-optic imaging device, comprising:
an acoustic wave source;
an acoustic lens system for converting a scattered wave produced by irradiation of an object with an acoustic wave emitted from the acoustic wave source into a predetermined converged state;
an acousto-optic medium section which is arranged such that a scattered wave transmitted through the acoustic lens system is incident on the acousto-optic medium section;
a light source for emitting a light beam which is formed by a plurality of superposed monochromatic light rays traveling in different directions, the light beam being incident on the acousto-optic medium section at an angle which is neither perpendicular nor parallel to an acoustic axis of the acoustic lens system;
an image formation lens system for condensing diffracted light of a plurality of the monochromatic plane wave light rays produced at the acousto-optic medium section; and
an image receiving section for detecting light condensed by the image formation lens system to output an electric signal.

2. The acousto-optic imaging device of claim 1, further comprising an image distortion correcting section for correcting distortion in at least one of an image of the object which is represented by the diffracted light and an image of the object which is represented by the electric signal.

3. The acousto-optic imaging device of claim 2, wherein a spectral width of each of the monochromatic light rays is less than 10 nm, and the monochromatic light ray is a plane wave whose wavefront accuracy is not more than ten times a wavelength of the monochromatic light ray at its center frequency.

4. The acousto-optic imaging device claim 1, wherein the acoustic lens system is a refractive acoustic system.

5. The acousto-optic imaging device of claim 4, wherein the acoustic lens system is formed by a silica nanoporous element or Fluorinert.

6. The acousto-optic imaging device of claim 5, wherein the acoustic lens system includes at least one refraction surface and an antireflection film provided on the at least one refraction surface for preventing reflection of an acoustic wave.

7. The acousto-optic imaging device of claim 1, wherein the acoustic lens system is a reflective acoustic system.

8. The acousto-optic imaging device of claim 7, wherein the acoustic lens system includes two or more reflection surfaces.

9. The acousto-optic imaging device of claim 1, wherein the acoustic lens system includes a focal length adjusting mechanism.

10. The acousto-optic imaging device of claim 1, wherein the image formation lens system includes a focal point adjusting mechanism.

11. The acousto-optic imaging device of claim 1, wherein the light source includes a plurality of fly-eye lenses.

12. The acousto-optic imaging device of claim 2, wherein the image distortion correcting section includes an optical member for magnifying a cross section of the diffracted light.

13. The acousto-optic imaging device of claim 2, wherein the image distortion correcting section includes an optical member for reducing a cross section of the diffracted light.

14. The acousto-optic imaging device of claim 12, wherein the optical member is formed by an anamorphic prism.

15. The acousto-optic imaging device of claim 12, wherein at least one of the image formation lens system and the optical member includes at least one cylindrical lens.

16. The acousto-optic imaging device of claim 2, wherein the image distortion correcting section performs image processing based on the electric signal.

17. The acousto-optic imaging device of claim 1, wherein the acousto-optic medium section includes at least one of a silica nanoporous element, Fluorinert, and water.

18. The acousto-optic imaging device of claim 1, wherein the diffracted light includes a component of Bragg diffracted light such that an intensity proportion of the Bragg diffracted light is not less than ½.

19. The acousto-optic imaging device of claim 1, wherein an optical axis of the light beam emitted from the light source is adjustable with respect to the acoustic axis of the acoustic lens system.

20. The acousto-optic imaging device of claim 1, wherein the acoustic wave is a pulsed acoustic wave.
